(19) United States
(12) Patent Application Publication
(10) Pub. No.: US 2019/0345041 A1
(43) Pub. Date: Nov. 14, 2019

(54) POROUS MINERAL NUCLEUS AND A METAL SHELL

(71) Applicant: B. G. NEGEV TECHNOLOGIES AND APPLICATIONS LTD., AT BEN-GURION UNIVERSITY, Beer Sheva (IL)

(72) Inventors: Taleb MOKARI, Beer Sheva (IL); Mahmmud DIAB, Beer Sheva (IL); Uri ABDU, Lehavim (IL); Sigal ABRAMOVICH, Lehavim (IL)

(21) Appl. No.: 16/331,345

(22) PCT Filed: Sep. 7, 2017
(86) PCT No.: PCT/IL2017/051009

§ 371 Date: Mar. 7, 2019

Related U.S. Application Data
(60) Provisional application No. 62/384,832, filed on Sep. 8, 2016.

(51) Int. Cl. C02F 1/28; C02F 1/30; C25B 1/04; C25B 11/03; C25B 11/04; B01J 20/04; B01J 20/28

(52) U.S. Cl. CPC C02F 1/288; C02F 1/30; C25B 1/04; C25B 11/035; C02F 2101/203; B01J 20/043; B01J 20/28085; B01J 20/28095; C02F 1/281; C25B 11/0478

(57) ABSTRACT

The present invention provides a composition of porous mineral nucleus and a shell, wherein the porous mineral nucleus has a porous surface and the shell includes a material selected from the group of: a metal, an organic molecule, or a combination thereof.

### CROSS-REFERENCE

This application claims the benefit of priority of U.S. Provisional Patent Application No. 62/384,832, filed on Sep. 8, 2016. The content of the above document is incorporated by reference in its entirety as if fully set forth herein.

### FIELD OF INVENTION

The present invention is in the field of fine nano and micro structures fabrication.

### BACKGROUND OF THE INVENTION

The formation of three-dimensional (3D) complex structures consist of nanofeatures with unique properties has been one of the major obstacles toward achieving a technological progress in various applications. The 3D structures that are comprised of nanofeatures increases the functionality of the materials and it enables a rational design to the desired properties. Fabrication of well-defined 3-D structures can be achieved either by lithographic or template-mediated methods.

Some examples of techniques in the lithographic approach are: photolithography, electron and ion-based lithographic, scanning probe lithographic, microcontact printing and others. Various structures with high quality/yield can be obtained through those techniques, however, these methods suffer from high cost, difficulty of fabrication of free-standing structures, and sometime the throughput is limited.

On the other hand, the templated approaches are usually easy, low cost and offer several and complex structure. Within these methods, the material of choice is grown/deposited on the chosen template (size and shape) to form the desired structure, then, the template can be fully/partially removed or not depended on the final application and on the difference between the solubility of the material and the template in various solvents.

### SUMMARY OF THE INVENTION

In one embodiment of the present invention there is provided a composition comprising porous mineral nucleus and a shell, wherein the porous mineral nucleus comprises a porous surface, the porous surface comprises at least 500 pores at a density of 500 to 5000 pores/cm², wherein each pore within the porous surface is 10 to 100 μm in diameter and 5 to 30 μm deep, wherein the pores are interconnected by a net of tunnels, wherein each tunnel of the tunnels is 1 to 40 μm in diameter, wherein the shell comprises a material selected from the group consisting of: a metal or an oxide thereof, a metal sulfide, an organic molecule, or a combination thereof.

In some embodiments, the metal comprises a metal oxide, or metal sulfide.

In some embodiments, the metal oxide or the metal sulfide are selected from the group consisting of Fe₂O₃, MnO, NiO, CdS, Cu₂₋ₓS, PbS, or any combination thereof.

In some embodiments, the metal is selected from the group consisting of: cobalt, zinc, potassium, tin, cadmium, lead, copper, gold, iron, or any combination thereof.

In some embodiments, the metal is cobalt.

In some embodiments, the composition is an electrocatalyst and is characterized by a current density of at least 250 mA/cm² in a water splitting process.

In some embodiments, the organic molecule comprises a polymer, a dye molecule or both.

In some embodiments, the dye molecule is Rhodamine.

In some embodiments, the porous mineral nucleus is derived from calcareous foraminifera. In some embodiments, the composition comprises a plurality of shells.

In some embodiments, the pores occupy 10 to 50% of the nucleus volume. In some embodiments, the pores occupy 10 to 50% of the nucleus surface area.

In some embodiments, the porous surface comprises at least 1000 pores.

In some embodiments, the density of 500 to 5000 pores/cm² is a density of 1500 to 4000 pores/cm².

In some embodiments, the 1 to 40 μm in diameter is 5 to 20 μm in diameter.

In one embodiment of the present invention there is provided an article comprising a material selected from the group consisting of: a metal, an organic molecule, or a combination thereof, wherein the article comprises a porous surface, the porous surface comprises at least 50 pores at a density of 500 to 5000 pores/cm², wherein each pore within the porous surface is 10 to 100 μm in diameter and 5 to 30 μm deep, wherein the pores are interconnected by a net of tunnels, wherein each tunnel of the tunnels is 1 to 40 μm in diameter.

In some embodiments, the material comprises a metal oxide or metal sulfide.

In some embodiments, the metal oxide or the metal sulfide are selected from the group consisting of Fe₂O₃, MnO, NiO, CdS, Cu₂₋ₓS, PbS, or any combination thereof.

In some embodiments, the metal is selected from the group consisting of: cobalt, zinc, potassium, tin, cadmium, lead, copper, gold, iron, or any combination thereof.

In some embodiments, the metal is cobalt.

In some embodiments, the article has a current density of at least 250 mA/cm².

In some embodiments, the organic molecule comprises a dye molecule. In some embodiments, the dye molecule is Rhodamine.

In some embodiments, the pores occupy 10 to 50% of the article volume. In some embodiments, the pores occupy 10 to 50% of the article surface area. In some embodiments, the porous surface comprises at least 500 pores.

In some embodiments, the density of 500 to 5000 pores/cm² is density of 1500 to 4000 pores/cm².

In some embodiments, the 1 to 40 μm in diameter is 5 to 20 μm in diameter.

In one embodiment of the present invention there is provided a process of fabricating the composition comprising porous calcareous nucleus and a shell, wherein the porous mineral nucleus is characterized by a pore density of 500 to 5000 pores/cm², and wherein the shell comprises a material selected from the group consisting of a metal, an organic molecule, or a combination thereof, the process comprising: (a) immersing a calcareous foraminifera in a metal precursor, thereby producing a mixture thereof;

(b) heating the mixture, thereby producing the composition.

In one embodiment of the present invention there is provided a method for purification of water comprising organic-based materials comprising the step of contacting the water with the disclosed composition or article in an embodiment thereof, thereby absorbing the organic-based materials in/on the composition.

In one embodiment of the present invention the disclosed composition or the article in an embodiment thereof, for use for removing contaminants from water.

### BRIEF DESCRIPTION OF THE DRAWINGS

Some embodiments of the invention are herein described, by way of example only, with reference to the accompanying drawings. With specific reference now to the drawing in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-I present optical images showing the generality of coating sorites with three groups of materials, metal oxide, metal sulfide and noble metals; α-Fe₂O₃ (FIG. 1A), MnO (FIG. 1B), NiO (FIG. 1C), CdS (FIG. 1D), Cu₂₋ₓS (FIG. 1E), PbS (FIG. 1F), Pt (FIG. 1G), Au (FIG. 1H), and μg (FIG. 1I).

FIGS. 2A-D present optical images of Sorites before and after heating 5 h at 500° C. in air (FIG. 2A and FIG. 2B, respectively). An optical image of Sorites after etching using 0.05 M HCl solution (2-3 min) (FIG. 2C) and the X-ray Diffraction (XRD) pattern of the Sorites before (upper trace) and after (bottom trace) heating process (FIG. 2D).

FIGS. 3A-D present scanning electron microscope (SEM) images of Sorites@α-Fe₂O₃ in low and high magnification (FIG. 3A and FIG. 3B, respectively); and energy dispersive x-ray spectroscopy (EDX) mapping images of Ca and Fe (FIG. 3C and FIG. 3D, respectively).

FIGS. 4A-D present SEM images of Sorites@MnO in low and high magnification images (FIG. 4A and FIG. 4B, respectively); and EDX mapping images of Ca and Mn (FIG. 4C and FIG. 4D, respectively).

FIGS. 5A-E present SEM and EDX images of Sorites@NiO in low and high magnification images (FIGS. 5A-B and FIG. 5C with the upper right inset therein, respectively); and EDX mapping images of Ca and Ni (FIG. 5D and FIG. 5E, respectively).

FIGS. 6A-F present SEM images of Sorites@CdS in low and high magnification images (FIGS. 6A-B, and FIG. 6C with the upper right inset therein, respectively); and EDX mapping image of Ca, Cd and S (FIG. 6D, FIG. 6E and FIG. 6F, respectively).

FIGS. 7A-E present SEM images of Sorites@Cu₂₋ₓS in low and high magnification images (FIG. 7A and FIG. 7B with the upper right inset therein, respectively); and EDX mapping images of Ca, Cu and S (FIG. 7C, FIG. 7D and FIG. 7E, respectively).

FIGS. 8A-E present SEM images of Sorites@PbS in low and high magnification images (FIG. 8A and FIG. 8B with the upper right inset image therein, respectively); and EDX mapping images of Ca, Pb and S (FIG. 8C, FIG. 8D and FIG. 8E, respectively).

FIGS. 9A-D present SEM images of Sorites@Pt in low and high magnification images (FIG. 9A and FIG. 9B with the upper right inset image therein, respectively). EDX mapping images of Ca and Pt (FIG. 9C and FIG. 9D, respectively).

FIGS. 10A-D present SEM images of Sorites@Au in low and high magnification images (FIG. 10A and FIG. 10B with the upper right inset image therein, respectively); and EDX mapping images of Ca and Au (FIG. 10C and FIG. 10D with the upper right inset image therein, respectively).

FIGS. 11A-D present SEM images of Sorites@Ag in low and high magnification images (FIG. 11A and FIG. 11B with the upper right inset image therein, respectively); and EDX mapping images of Ca and Ag (FIG. 11C and FIG. 11D, respectively).

FIGS. 12A-C present an optical image of Sorites coated Fe₃O₄ (FIG. 12A) and low and high (inset) magnification SEM images of Sorites@Fe₃O₄ (FIG. 12B with the upper right inset image therein); and XRD pattern of the Sorites@Fe₃O₄ (FIG. 12C). XRD signals of both Fe and Fe₃O₄ crystalline phases are observed.

FIGS. 13A-D present SEM images of Sorites@SnO in low and high magnification images (FIG. 13A and FIG. 13B with the upper right inset image therein, respectively); and EDX mapping images of Ca and Sn (FIG. 13C and FIG. 13D, respectively).

FIGS. 14A-E present SEM images of Sorites@ZnS in low and high magnification images (FIG. 14A and FIG. 14B, respectively); and EDX mapping images of Ca, Zn, and S (FIG. 14C to FIG. 14E, respectively).

FIGS. 15A-F present an optical image of Sorites@CoS (FIG. 15A), low and high magnification SEM images of Sorites@CoS (FIG. 15B and FIG. 15C with the upper right inset therein, respectively); and EDX mapping images of Ca, Co and S (FIG. 15D, FIG. 15E and FIG. 15F, respectively).

FIGS. 16A-C present an optical image of Sorites@Cu (FIG. 16A), and low and high (inset) magnification SEM images of Sorites@Cu (FIG. 16B with the upper right inset therein); and XRD pattern of Sorites@CuCl₂(Cu(OH)₂)₃ (upper panel) and Sorites@Cu (lower panel) (FIG. 16C).

FIGS. 17A-C present SEM images of top view of multiple layers complex structure; Sorites@Co@ZnO (FIG. 17A), Sorites@Co@FeOOHₓ (FIG. 17B) and Sorites@Co@FeOOHₓ@CdS (FIG. 17C).

FIGS. 18A-I present SEM images of top view of multiple layers complex structure; Sorites@Co@ZnO (FIG. 18A with the upper right inset image therein), Sorites@Co@FeOOHₓ (FIG. 18B with the upper right inset image therein) and Sorites@Co@FeOOHₓ@CdS (FIG. 18C with the upper right inset image therein); and EDX mapping of the complex structures; Ca (FIG. 18D), Co in Sorites@Co, Sorites@Co@ZnO and Sorites@Co@Fe(OH)ₓ (FIG. 18E, FIG. 18F and FIG. 18G, respectively), Zn (FIG. 18H) and Fe (FIG. 18I).

FIGS. 19A-H present a structural characterization of multiple layers complex structure. High magnification SEM images of sorites coated with Co (FIG. 19A), Co@FeOOHₓ (FIG. 19B), Co@FeOOHₓ@CdS (FIG. 19C) and corresponding cross section image (FIG. 19F). EDX mapping of Co@FeOOHₓ@CdS structure; Co (FIG. 19D), iron (FIG. 19E), Cd (FIG. 19G) and S (FIG. 19H).

FIGS. 20A-I present structural characterization, XRD and EDX mapping (inset), of the Sorites with different coated materials. α-Fe₂O₃, the inset shows EDX mapping of Fe (FIG. 20A); MnO, the inset shows EDX mapping of Mn (FIG. 20B); NiO, the inset shows EDX mapping of Ni (FIG. 20C); CdS, the inset shows EDX mapping of Cd and S (FIG. 20D); Cu₂₋ₓS, the inset shows EDX mapping of Cu and S (FIG. 20E); PbS, the inset shows EDX mapping of Pb and S (FIG. 20F); Pt, the inset shows EDX mapping of Pt (FIG. 20G); Au, the inset shows EDX mapping Au (FIG. 20H); and Ag, the inset shows EDX mapping of Ag (FIG. 20I).

FIGS. 21A-L present SEM images (FIGS. 21A, 21B, 21E, 21F, 21I, 21J and insets therein) and EDX mapping (FIGS. 21C, 21D, 21G, 21H, 21K, and 21L, showing coating various spices from foraminifera family with Co particles: Sorites@Co (FIG. 21A and FIG. 21C), Globigerinella siphonifera@Co (FIG. 21B and FIG. 21D) Loxostomina amygdaleformis@Co (FIG. 21E and FIG. 21G), Calcarina baculatus@Co (FIG. 21F and FIG. 21H), Calcarina hispida@Co (FIG. 21I and FIG. 21K) and Peneroplis planatus@Co (FIG. 21J and FIG. 21L).

FIGS. 22A-J present SEM images of the 3-D structure after removing the CaCO₃ template: top image view after etching process when Sorites, and Globigerinella siphonifera are used as templates (FIG. 22A and FIG. 22F, respectively, with insets therein); SEM images of cross section view of the 3D structure (FIG. 22B+FIG. 22D and FIG. 22G+FIG. 22I); and EDX mapping images of the S-D structure before and after etching process (FIG. 22C+FIG. 22E and FIG. 22H+FIG. 22J), when Sorites, and Globigerinella siphonifera were used as a template, respectively.

FIGS. 23A-C present EDX mapping images of Sorites@Co (FIG. 23A) and Globigerinella siphonifera@Co (FIG. 23B) after removing the CaCO₃ template; XRD of Sorites@Co (bottom trace), after oxidation of Co to obtain Sorites@Co₃O₄ (middle trace) and after removing the template and obtaining pure Co₃O₄ (upper trace) (FIG. 23C).

FIG. 24 presents a snapshot from a video record, shows the magnetic properties of Sorites@Co.

FIGS. 25A-E present water oxidation reaction using the Sorites@Co (dotted line) and Sorites@NiO (dashed line), silver paint (full line) on Cu electrode and, inset show optical image of the electrodes, on the left the Sorites@Co, on the middle Sorites@NiO and on the right the silver paint (FIG. 25A); Adsorption of Rhodamine 6G on Sorites before (i) and after surface modification with MUA (ii), Sorites@CdS (iii), Sorites@CdS first cycle (iv) and Sorites@CdS second cycle (v) (FIG. 25B); FIG. 25C presents optical images of the Sorites before and after the adsorption (upper and lower images, respectively) and Sorites@CdS before and after adsorption (FIG. 25D, upper and lower images, respectively); FIG. 25E presents photodegradation of rhodamine 6G under 405 nm light illumination using sorites@CdS (full line) and Sorites@CdS—Au (dotted line).

FIGS. 26A-B present adsorption of various dye molecules (Rh6G, RhB and MB) on Sorites surface (FIG. 26A), and optical images of Sorites before and after adsorption of the dye molecules (FIG. 26B).

FIG. 27 presents photographic images of Sorites-MUA and Sorites@CdS-MUA before and after adsorption of various dye molecules

FIGS. 28A-D present an optical image (FIG. 28A) of the filter and a schematic description of the filtration process in which three different metal pollutions were filtered, and bar graphs (FIGS. 28B-D) showing their concentration checked by atomic absorption before and after the filtration: Lead Acetate, >99.98% were removed (FIG. 28B); Cadmium chloride, >99.9% were removed (FIG. 28C); and Copper Chloride, >99.99% were removed (FIG. 28D). The insets in FIG. 28B, FIG. 28C and FIG. 28D show the amount of the metals before and after filtration in a logarithmic scale. The upper arrow of FIG. 28A marks high contaminant concentration. The lower arrow of FIG. 28A marks lower contaminant concentration.

### DETAILED DESCRIPTION OF THE INVENTION

The present invention, in some embodiments thereof, is directed to well-defined 3-D structures using diatoms spices as a template. In one embodiment, a mineral scaffold derived from diatom is used as a template or a nucleus according to the present invention. In one embodiment, a mineral scaffold, a template or a nucleus of the present invention comprises a 3D nanoporous structure. In one embodiment, a mineral scaffold, a template or a nucleus of the present invention comprises a 3D microporous structure. In one embodiment, a mineral scaffold, a template or a nucleus of the present invention is a mesoporous 3D structure of CaCO₃ at various shapes, and sizes with complex internal and external structures. In one embodiment, a mineral scaffold, a template or a nucleus of the present invention is a calcareous Foraminiferals shell. In one embodiment, a mineral scaffold, a template or a nucleus of the present invention is a mineral nucleus. In one embodiment, a mineral nucleus is a porous mineral nucleus.

In one embodiment, there is provided herein a composition comprising a porous mineral nucleus and a shell, wherein the porous mineral nucleus comprising a porous surface, the porous surface comprises at least 100 pores at a density of 50 to 10000 pores/cm², wherein each pore within the porous surface is 5 to 500 μm in diameter and 1 to 100 μm deep, wherein the pores are interconnected by a net of tunnels, wherein each tunnel of the tunnels is 1 to 80 μm in diameter, wherein the shell comprises a material selected from the group of: a semiconductor, a polymer, a metal, an organic molecule, or a combination thereof.

In one embodiment, the porous surface comprises at least 500 pores. In one embodiment, the porous surface comprises at least 5000 pores. In one embodiment, the porous surface comprises from 500 to 100,000,000 pores. In one embodiment, the porous surface comprises from 500 to 10,000,000 pores. In one embodiment, the porous surface comprises from 100 to 1,000,000 pores.

In one embodiment, the pores are at a density of 100 to 10000 pores/cm². In one embodiment, the pores are at a density of 200 to 5000 pores/cm². In one embodiment, the pores are at a density of 500 to 4000 pores/cm². In one embodiment, the pores are at a density of 1500 to 5000 pores/cm². In one embodiment, the pores are at a density of 1500 to 4000 pores/cm². In one embodiment, the pores are at a density of 2000 to 3500 pores/cm².

In one embodiment, each pore within the porous surface is 5 to 500 μm in diameter. In one embodiment, each pore within the porous surface is 10 to 500 μm in diameter. In one embodiment, each pore within the porous surface is 5 to 100 μm in diameter. In one embodiment, each pore within the porous surface is 10 to 250 μm in diameter.

In one embodiment, each pore within the porous surface is 1 to 300 μm deep. In one embodiment, each pore within the porous surface is 1 to 100 μm deep. In one embodiment, each pore within the porous surface is 5 to 200 μm deep. In one embodiment, each pore within the porous surface is 10 to 100 μm deep. In one embodiment, each pore within the porous surface is 20 to 60 μm deep.

In one embodiment, the porous mineral nucleus comprises calcium carbonate. In one embodiment, the porous mineral nucleus comprises calcium phosphate.

In one embodiment, the pores occupy 5 to 70% of the nucleus volume. In one embodiment, the pores occupy 5 to 50% of the nucleus volume. In one embodiment, the pores occupy 30 to 50% of the nucleus volume. In one embodiment, the pores occupy 20 to 60% of the nucleus volume. In one embodiment, the pores occupy 50 to 80% of the nucleus volume. In one embodiment, the pores occupy 50 to 70% of the nucleus volume. In one embodiment, the pores occupy at least 30% of the nucleus volume. In one embodiment, the pores occupy at least 40% of the nucleus volume. In one embodiment, the pores occupy at least 50% of the nucleus volume. In one embodiment, the pores occupy at least 60% of the nucleus volume.

In one embodiment, a pore is a structure having at least one opening on the surface of the nucleus. In one embodiment, a pore is a structure having at least two openings: the first opening is on the surface of the nucleus; and the second opening defines a fluid connection to at least one tunnel. In one embodiment, a pore is a structure having at least one opening on the surface of the nucleus. In one embodiment, a pore is defined by a mineral surface and an opening. In one embodiment, the mineral surface area is at least 1.5 times larger than the opening surface area. In one embodiment, the mineral surface area is at least 2 times larger than the opening surface area. In one embodiment, the mineral surface area is at least 2.5 times larger than the opening surface area. In one embodiment, the mineral surface area is at least 5 times larger than the opening surface area. In one embodiment, the mineral surface area is at least 10 times larger than the opening surface area.

In one embodiment, a tunnel is a structure having at least one opening on the surface of the nucleus. In one embodiment, a tunnel is a structure having at least two openings: the first opening is on the surface of the nucleus; and the second opening defines a fluid connection to at least one pore. In one embodiment, a tunnel is a structure having at least one opening on the surface of the nucleus. In one embodiment, a tunnel is defined by a mineral surface and an opening. In one embodiment, the mineral surface area is at least 1.5 times larger than the opening surface area. In one embodiment, the mineral surface area is at least 2 times larger than the opening surface area. In one embodiment, the mineral surface area is at least 2.5 times larger than the opening surface area. In one embodiment, the mineral surface area is at least 5 times larger than the opening surface area. In one embodiment, the mineral surface area is at least 10 times larger than the opening surface area.

In one embodiment, the pores occupy 5 to 70% of the nucleus surface area. In one embodiment, the pores occupy 5 to 50% of the nucleus surface area. In one embodiment, the pores occupy 30 to 50% of the nucleus surface area. In one embodiment, the pores occupy 20 to 60% of the nucleus surface area. In one embodiment, the pores occupy 50 to 80% of the nucleus surface area. In one embodiment, the pores occupy 50 to 70% of the nucleus surface area. In one embodiment, the pores occupy at least 30% of the nucleus surface area. In one embodiment, the pores occupy at least 40% of the nucleus surface area. In one embodiment, the pores occupy at least 50% of the nucleus surface area. In one embodiment, the pores occupy at least 60% of the nucleus surface area.

In one embodiment, elongated bulges, bulges or protrusions are formed on or within the shell or article with the dimension of the pores and the tunnels as described herein. In one embodiment, shell's or article's elongated bulges, bulges or protrusions are the result of deposing the shell or article onto the nucleus. In one embodiment, shell's elongated bulges, bulges or protrusions are the “negative” of the nucleus' pores and tunnels. In one embodiment, shell's or article's elongated bulges, bulges and/or protrusions are the result of deposing the shell's or article's material in onto the surface of the nucleus. In one embodiment, shell's or article's elongated bulges, bulges and/or protrusions are the result of deposing the shell's or article's material in a liquid form onto the surface of the nucleus.

In one embodiment, the porous surface comprises at least 1000 pores. In one embodiment, the porous surface comprises at least 5000 pores. In one embodiment, the porous surface comprises at least 10000 pores. In one embodiment, the porous surface comprises at least 100,000 pores. In one embodiment, the porous surface comprises at least 500,000 pores. In one embodiment, the porous surface comprises at least 1,000,000 pores.

In one embodiment, the density of the pores is 100 to 10000 pores/cm². In one embodiment, the density of the pores is 500 to 5000 pores/cm². In one embodiment, the density of the pores is 1500 to 4000 pores/cm². In one embodiment, the density of the pores is 2000 to 4000 pores/cm².

In one embodiment, the tunnels are of 1 to 80 μm in diameter. In one embodiment, the tunnels are of 1 to 40 μm in diameter. In one embodiment, the tunnels are of 5 to 50 μm in diameter. In one embodiment, the tunnels are of 10 to 60 μm in diameter. In one embodiment, the tunnels are of 15 to 50 μm in diameter. In one embodiment, the tunnels are of 5 to 20 μm in diameter.

In one embodiment, the metal comprises a semiconductor, a polymer, a metal oxide or a metal sulfide. In one embodiment, a metal oxide or a metal sulfide comprise Fe₂O₃, MnO, NiO, CdS, Cu₂₋ₓS, PbS, or any combination thereof. In one embodiment, the metal is: cobalt, zinc, potassium, tin, cadmium, lead, copper, gold, iron, or any combination thereof.

In one embodiment, the semiconductor comprises a N-type semiconductor material. In one embodiment, the semiconductor comprises an intrinsic semiconductor material. In one embodiment, the semiconductor comprises an extrinsic semiconductor material. In one embodiment, the semiconductor comprises a p-type semiconductor material. In one embodiment, the semiconductor comprises a Gallium material. In one embodiment, the semiconductor comprises a silicon material. In one embodiment, the semiconductor comprises a Germanium material. In one embodiment, the semiconductor comprises a lead material. In one embodiment, the semiconductor comprises a cadmium material. In one embodiment, the semiconductor comprises Gallium phosphide. In one embodiment, the semiconductor comprises Gallium arsenide. In one embodiment, the semiconductor comprises Silicon carbide. In one embodiment, the semiconductor comprises Gallium Nitride. In one embodiment, the semiconductor comprises Cadmium sulphide. In one embodiment, the semiconductor comprises Lead sulphide.

In one embodiment, the composition or the shell has a current density of at least 250 mA/cm². In one embodiment, the composition or the shell has a current density of 100 to 550 mA/cm². In one embodiment, the composition or the shell has a current density of at least 300 mA/cm². In one embodiment, the composition or the shell has a current density of 50 to 1000 mA/cm².

In one embodiment, the organic molecule comprises a dye molecule. In one embodiment, the organic molecule comprises Rhodamine.

In one embodiment, the composition comprises a plurality of shells. In one embodiment, the composition comprises 1 to 50 shells. In one embodiment, the composition comprises 5 to 10 shells. In one embodiment, the composition comprises 2 to 10 shells. In one embodiment, the composition comprises 1-4 shells.

In one embodiment, provided herein an article comprising a material selected from the group consisting of: a semiconductor, a polymer, a metal, an organic molecule, or a combination thereof, wherein the article comprises a porous surface, the porous surface comprises at least 50 pores at a density of 500 to 5000 pores/cm², wherein each pore within the porous surface is 10 to 100 μm in diameter and 5 to 30 μm deep, wherein the pores are interconnected by a net of tunnels, wherein each tunnel of the tunnels is 1 to 40 μm in diameter.

In one embodiment, provided herein an article comprising a material selected from the group consisting of: a semiconductor, a polymer, a metal, an organic molecule, or a combination thereof, wherein the article comprises a bulged surface, the bulged surface comprises at least 50 pores, bumps, or protrusions at a density of 500 to 5000 [pores, bumps, or protrusions/cm²], wherein each pores, bumps, or protrusions within the bulged surface is 10 to 100 μm in diameter and 5 to 30 μm deep, wherein the pores, bumps, or protrusions are interconnected by a net of tunnels or elongated bulges, wherein each tunnel or elongated bulge of the tunnels or elongated bulges is 1 to 40 μm in diameter.

In some embodiments, the article is selected from: an agricultural device, and a microfluidic device. In some embodiments, the article is a filter for water purification.

In some embodiments, the article is a filter or a membrane in a water purification device.

In one embodiment, the length of a tunnel or an elongated bulge is at least 2 times its width. In one embodiment, the length of a tunnel or an elongated bulge is at least 3 times its width. In one embodiment, the length of a tunnel or an elongated bulge is at least 4 times its width. In one embodiment, the length of a tunnel or an elongated bulge is at least 5 times its width. In one embodiment, the length of a tunnel or an elongated bulge is at least 10 times its width. In one embodiment, the length of a tunnel or an elongated bulge is at least 20 times its width. In one embodiment, the length of a tunnel or an elongated bulge is at least 50 times its width.

In one embodiment, a tunnel or an elongated bulge is hollow. In one embodiment, a tunnel or an elongated bulge is a cavity. In one embodiment, a tunnel or an elongated bulge is a hollowed cavity. In one embodiment, pores, bumps, or protrusions are hollow. In one embodiment, pores, bumps, or protrusions are cavities. In one embodiment, pores, bumps, or protrusions are hollowed cavities. In one embodiment, a tunnel or an elongated bulge is devoid of an opening. In one embodiment, a tunnel or an elongated bulge is devoid of a surface facing opening. In one embodiment, a tunnel or an elongated bulge comprises an opening. In one embodiment, a tunnel or an elongated bulge comprises a surface facing opening. In one embodiment, bumps or protrusions are devoid of an opening. In one embodiment, bumps or protrusions are devoid of a surface facing opening . . . . In one embodiment, bumps, or protrusions comprise an opening.

In one embodiment, the length of a tunnel or an elongated bulge is at least 2 times its depth. In one embodiment, the length of a tunnel or an elongated bulge is at least 3 times its depth. In one embodiment, the length of a tunnel or an elongated bulge is at least 4 times its depth. In one embodiment, the length of a tunnel or an elongated bulge is at least 5 times its depth. In one embodiment, the length of a tunnel or an elongated bulge is at least 10 times its depth. In one embodiment, the length of a tunnel or an elongated bulge is at least 20 times its depth. In one embodiment, the length of a tunnel or an elongated bulge is at least 50 times its depth.

In one embodiment, a metal is any metal known to one of skill in the art. In one embodiment, a metal is a metal oxide. In one embodiment, a metal is a metal sulfide. In one embodiment, a metal is a combination of metals. In one embodiment, a metal is a combination of a metal and a metal oxide. In one embodiment, a metal is a combination of a metal and a metal sulfide. In one embodiment, a metal is a combination of a metal oxide and a metal sulfide. In one embodiment, a metal is a combination of a metal, a metal oxide, and a metal sulfide.

In one embodiment, a metal comprises Fe₂O₃. In one embodiment, a metal comprises MnO. In one embodiment, a metal comprises NiO. In one embodiment, a metal comprises CdS. In one embodiment, a metal comprises Cu₂₋ₓS. In one embodiment, a metal comprises PbS. In one embodiment, a metal comprises any combination of Fe₂O₃, MnO, NiO, CdS and Cu₂₋ₓS.

In one embodiment, a metal comprises cobalt. In one embodiment, a metal comprises zinc. In one embodiment, a metal comprises potassium. In one embodiment, a metal comprises cadmium. In one embodiment, a metal comprises tin. In one embodiment, a metal comprises lead. In one embodiment, a metal comprises copper. In one embodiment, a metal comprises gold. In one embodiment, a metal comprises silver. In one embodiment, a metal comprises iron. In one embodiment, a metal comprises any combination of: silver, cobalt, zinc, potassium, tin, cadmium, lead, copper, gold and iron.

In one embodiment, the article has a current density of at least 50 mA/cm². In one embodiment, the article has a current density of at least 100 mA/cm². In one embodiment, the article has a current density of at least 150 mA/cm². In one embodiment, the article has a current density of at least 200 mA/cm². In one embodiment, the article has a current density of at least 250 mA/cm². In one embodiment, the article has a current density of at least 500 mA/cm². In one embodiment, the article has a current density of at least 750 mA/cm². In one embodiment, the article has a current density of 50 to 1000 mA/cm². In one embodiment, the article has a current density of 100 to 700 mA/cm². In one embodiment, the article has a current density of 200 to 500 mA/cm².

In one embodiment, the organic molecule comprises a dye such as but not limited to Rhodamine.

In one embodiment, pores occupy 5 to 50% of the article's volume. In one embodiment, pores occupy 5 to 30% of the article's volume. In one embodiment, pores occupy 10 to 80% of the article's volume. In one embodiment, pores occupy 20 to 40% of the article's volume. In one embodiment, pores occupy 15 to 30% of the article's volume. In one embodiment, pores occupy 10 to 50% of the article's volume.

In one embodiment, a porous surface is a bulged surface. In one embodiment, the article's surface is a bulged surface. In one embodiment, the shell's surface is a bulged surface. In one embodiment, a bulged surface comprises at least 50 bulges or protrusions. In one embodiment, a bulged surface comprises at least 100 bulges or protrusions. In one embodiment, a bulged surface comprises at least 500 bulges or protrusions. In one embodiment, a bulged surface comprises at least 5000 bulges or protrusions.

In one embodiment, a bulged surface comprises at least 10 elongated bulges. In one embodiment, a bulged surface comprises at least 50 elongated bulges. In one embodiment, a bulged surface comprises at least 100 elongated bulges. In one embodiment, a bulged surface comprises at least 500. In one embodiment, a bulged surface comprises at least 100 elongated bulges. In one embodiment, a bulged surface comprises at least 5000 elongated bulges.

In one embodiment, a bulged surface has a bulge/protrusion density of 100 to 5000 bulges/protrusions/cm². In one embodiment, a bulged surface has a bulge/protrusion density of 500 to 5000 bulges/protrusions/cm². In one embodiment, a bulged surface has a bulge/protrusion density of 1000 to 5000 bulges/protrusions/cm². In one embodiment, a bulged surface has a bulge/protrusion density of 1500 to 4000 bulges/protrusions/cm². In one embodiment, a bulged surface has a bulge/protrusion density of 2000 to 4500 bulges/protrusions/cm².

In one embodiment, provided herein a process of fabricating the composition as described herein, the process comprising: (a) immersing a calcareous foraminifer in a metal precursor, thereby producing a mixture thereof; and (b) heating the mixture, thereby producing the composition. In one embodiment, provided herein a process of fabricating the shell-nucleus composition as described herein, the process comprising: (a) immersing a nucleus such as a calcareous foraminifer nucleus, in a metal precursor, thereby producing the shell-nucleus composition; and (b) heating the mixture, thereby producing the shell-nucleus composition. In one embodiment, heating is melting the shell's or article's material. In one embodiment, heating is enabling the penetration of the shell's or article's material into the pores and into the tunnels present on the surface of the nucleus.

In one embodiment, a nucleus as described herein is a Sorites@Co₃O₄. Further exemplary embodiments are described hereinthroughout and in the Examples section that follows. In one embodiment, a nucleus as described herein is used in a process for electrocatalyic water oxidation. In one embodiment, a nucleus as described herein is electrocatalyst characterized by a current density of e.g., at least 50 mA/cm², at least 100 mA/cm², at least 200 mA/cm², at least 250 mA/cm², or at least 300 mA/cm² in a water splitting process.

In one embodiment, a nucleus as described herein is used in a process for photocatalytic oxidation of benzyl alcohol to benzaldehyde.

In one embodiment, there is provided a process of water purification, the process comprising contacting the disclosed composition or the disclosed article in an embodiment thereof, with water having a contaminant component (or components), thereby absorbing the contaminant onto the composition.

In one embodiment, the contacting” is applied for a time duration of at least 30 sec up to at least 30 min.

In some embodiments, by “water purification”, it is meant to refer to removing contaminant(s) (also referred to as “pollutant(s)”) from the contaminated water. In some embodiments, by “water purification”, it is meant to refer to absorbing the contaminants onto the disclosed composition or on a portion of the disclosed article. In some embodiments, by “absorbing” it is meant to refer to at least 10%, least 20%, at least 30%, least 40%, at least 50%, least 60%, at least 70%, least 80%, at least 90%, least 95%, at least 99%, or least 99.9%, by weight, of the contaminants in the water being absorbed on the disclosed composition or on a portion of the disclosed article.

In some embodiments, by “contaminated water”, it is meant to refer to contaminants in the water being in a concentration of at least e.g., 10 ppm, 20 ppm, 30 ppm, 40 ppm, 50 ppm, 60 ppm, 70 ppm, 80 ppm, or at least 100 ppm of the contaminants in the water.

In one embodiment, the present process is effective for treating one or more contaminant components, e.g., inorganic- and organic-based components, such as hydrocarbons, and/or organic-based components.

Non-limiting examples of inorganic-based component include salts, for example and without being limited thereto, lead acetate, cadmium chloride, and copper chloride.

Examples of organic-based and hydrocarbon-based contaminant components which may be processed in accordance with the present invention include, but are not limited to, petroleums (crude oils including topped crude oils), organic acids such as benzoic acid, ketones, aldehydes, aromatic components including phenols and the like, organic materials and dyes.

In some embodiments, by purification process, it is meant that the concentration of the contaminants in the purified water (i.e. upon applying disclosed process) is less than 0.1 ppm, less than 0.01 ppm, or less than 0.005 ppm.

### General

As used herein the term “about” refers to ±10%.

The terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Example 1-Sorties (Nucleus)-Shell Fabrication

Solvents and reagents were purchased from Sigma-Aldrich, Strem Chemicals and Alfa Aesa and used without any further purification. Cobalt acetate (Co(ac)₂ 99.995%), Iron (II) acetate (Fe(ac)₂, 99.995%), Zinc (II) acetate (Zn(ac)₂, 99.99%), sodium diethyldithiocarbamate (NaS₂CN(C₂H₅)₂, 99%), Silver nitrate (AgNO₃, 99%) and Potassium hydroxide (KOH, 90%), 11-mercaptoundecanoic acid (MUA, 95%) were purchased from Sigma Aldrich. Nickel (II) acetate tetrahydrate (Ni(ac)₂.4H₂O, >98%), Manganese (II) acetate (Mn(ac)₂, 98%), Tin (II) acetate (Sn(ac)₂, 99%), Cadmium acetate Dihydrate (Cd(ac)₂.2H₂O, 98%), Copper (II) Chloride (CuCl₂, 98%), lead acetate trihydrate (Pb(ac)₂.3H₂O, 99.99%), Zn(II) acetate dihydrate (Zn(ac)₂.2H₂O, 98%), Zinc (II) nitrate hexahydrate (Zn(NO₃)₂.6H₂O, 98%), Cobalt (II) acetate tetrahydrate (Co(ac)₂.4H₂O, 98%), Gold (III) Chloride (AuCl₃, 99.99%), Chloroplatinic acid hexahydrate (H₂PtCl₆.6H₂O, 99.9%) and Trioctylphosphine (TOP, 97%) was purchased from Strem. Iron (II) sulfate heptahydrate (FeSO₄.7H₂O, 99%), Hexamethylenetetramine (HMTA, 99%)) and Hexadecylamine (HDA, 90%) were purchased from Alfa Aesa. Deionized (DI) water was purified using a Millipore Direct-Q system (18.2 MW·cm resistivity).

Sorites Pretreatment:

The sorites (nucleus-scaffold) were first immersed in a bleach solution for 3 hr. Followed by heating at 500° C. for 5 hr. Then the sorites were transferred to 0.05 M HCl solution for 2-3 min in order to etch the top layer of the sorites (make access to their holes).

Coating the Sorites with Metal Oxides Nanostructure:

40 mg of M(Co, Ni, Fe, Mn, Zn, and Sn)-(ac)₂ was dissolved in 1 mL HDA. Then, 20 mL vial which contain the Sorites (10 mg) and 500 pL of the metal acetate solution was placed on heating (plate inside a glove box) and it was heated at 270° C. for 20 min except the cobalt, it was heated at 300° C. for 30 min. The product was cleaned by hexane and dried at 60° C. This procedure was repeated another time.

Coating the Sorites with Metal Sulfide Nanostructure:

20 mg of single source precursor (SSP) of Metal (Cd, Cu, Pb, Zn and Co)-bisdiethyldithiocarbamate (the SSP were synthesized based on a previously published method)ⁱ was dissolved in 1 mL TOP. Then, 25 mL beaker which contain the Sorites (10 mg) and 500 pL of the SSP stock solution was placed on heating (plate inside a glove box) and it was heated at 270° C. for 30 min (until complete evaporation of the TOP) except the cupper sulfide, it was heated at 300° C. The product was cleaned by hexane and dried at 60° C. This procedure was repeated another time.

Coating the Sorites with Metal Nanostructure:

5 mg of metal salt (AuCl₃, H₂PtCl₄ and AgNO₃) was dissolved in deionized water (3 mL) mixed with methanol (1 mL). Then, 20 mL vial which contain sorites (18 mg) and 500 pL of the metal salt solution was irradiate with UV LED (365 nm) for 1 hr. This procedure was repeated another time while the sorites were exposed to the other side.

Coating the Sorites with Metal Oxides Nanostructure:

40 mg of M(Co, Ni, Fe, Mn, Zn, and Sn)-(ac)2 was dissolved in 1 mL HDA. Then, 20 mL vial which contain the Sorites (10 mg) and 500 pL of the metal acetate solution was placed on heating (plate inside a glove box) and it was heated at 270° C. for 20 min except the cobalt, it was heated at 300° C. for 30 min. The product was cleaned by hexane and dried at 60° C. This procedure was repeated another time.

Fabrication of Complex Structure:

Coating the Sorites with Fe(OH)ₓ:

adding 10 mL of 0.1 M iron salt (FeSO₄.7H₂O, pH=3) aqueous solution into vial contains 0.5 g of Sorites. The iron solution was removed after 30 min, and the Sorites with the adsorbed iron salt were heated at 90° C.

Sorites@Co@Fe(OH)ₓ: An oil bath was heated to the 90° C. In a typical experiment, 10 mL of a 0.1 M iron salt (FeSO₄.7H₂O) aqueous solution was placed inside a 20 mL vial. The Sorites@Co spices were placed inside the vial. After 45 min reaction, the Sorites spices were taken out and cleaned by DI water and then dried at 60° C.

Sorites@Co@ZnO: A 5 mM “seeding solution” was prepared by dissolving Zn(ac)₂.2H₂O in ethanol at room temperature followed by heating to 50° C. for 20 min to insure complete dissolution of the salt. The following “seeding procedure” was repeated twice: first, the Sorites@Co was dipped into the “seeding solution” for ˜10 s, and the Sorites@Co was taken out for 2 min to ensure complete evaporation of the solvent. This was repeated 5 times, after which, the Sorites@Co spices were put into a tube furnace open to the atmosphere, at 350° C. for 30 min. Then, 20 mL scintillation vials were filled with 12 mL of a 0.025 M equimolar solution of Zn(NO₃)₂.6H₂O, and 5 mM HMTA in DI water. The vials were heated to 90° C. for 120 min. At the end of the reaction, the vials were cooled for ˜15 min, and then the Sorites@Co@ZnO were thoroughly washed with DI water.

Etching Process:

Sorites and Globigerinella siphonifera that were coated with cobalt nanostructures were heated at 550° C. for 5 hr for conversion of Co metal to Co₃O₄. Then the cobalt oxide structures were transfer to 0.1 M HCl solution for 20 min for complete etching of Sorites and few min in the case of Globigerinella siphonifera (the structure were immersed again in 0.1 M HCl to make sure that the CaCO₃ was fully removed).

Atomic Absorption Spectroscopy Measurement:

The metal concentration was measured by atomic absorption spectroscopy using Perkin Elmer Analyst 400. The sample was first filtered with syringe filter made of PVDF with 0.22 μm pore diameter and then the content of the metals solutions was measured by the atomic absorption spectroscopy in triplicate. A calibration curve was performed using a standard solution before each measurement.

PEC Measurements.

The working electrode was made by pasting the Sorites@Co pieces with either colloidal graphite or by soldering with Sn on Cu electrode, then the electrode was heated a few minutes at 150° C. The PEC measurement of the cobalt films was carried out in a 1 M KOH solution, using a VersaSTAT 3 potentiostat in a three-electrode system. The cobalt oxide film acts as the working electrode, a platinum wire as the counter electrode, and Ag/AgCl in saturated KCl as the reference electrode, separated by glass frits. The voltage was swept between 0 and +1 V vs Ag/AgCl at a scan rate 20 mV/s.

Adsorption Experiment:

In this section, the ability of the Sorites@CdS to adsorb Rhodamine 6G on its surface in aqueous solution, was examined, therefore, the Sorites@CdS were underwent ligand exchange procedure. Briefly, 0.048 g of Sorites@CdS were transferred to MUA solution (0.1 g of MUA was dissolved in 5 mL chloroform). Followed by vigorously shaken for 5 minutes. Then the Sorites@CdS were washed with chloroform, ethanol and acetone separately. Finally, the Sorites@CdS were transferred to KOH solution (2.25 mL DI water and 0.25 mL 1 M KOH). A stock solution of Rhodamine 6G was prepared in pH 10 of aqueous solution, where the concentration was adjusted that the absorbance at 524 nm is 0.64.

Photocatalytic Activity:

the photodegradation of Rhodamine 6G was carried out using Sorites@CdS and Sorites@CdS—Au as catalysts and 405 nm LED as the light source.

Structural Characterization:

Scanning electron microscopy (SEM) was performed using a JEOL SM-7400F ultrahigh-resolution with a cold-field emission-gun. SEM instrument was operated at 3.5 kV. The energy-dispersive X-ray spectroscopy (EDX) was detected by using EDX which was coupled with the SEM and it was operated at an accelerating voltage of 15 kV. Phase analysis of the samples was carried out using the X-ray diffraction (XRD) method. The data was collected on Empyrean Powder Diffractometer (Panalytical) equipped with position sensitive (PSD) X'Celerator detector using Cu Kα radiation (λ=1.5418 Å) and operated at 40 kV and 30 mA. UV-Vis absorbance measurements were made using a Cary 5000 UV-Vis-NIR spectrophotometer.

### Example 2

### Results

Growth of Various Materials Sorites Shell:

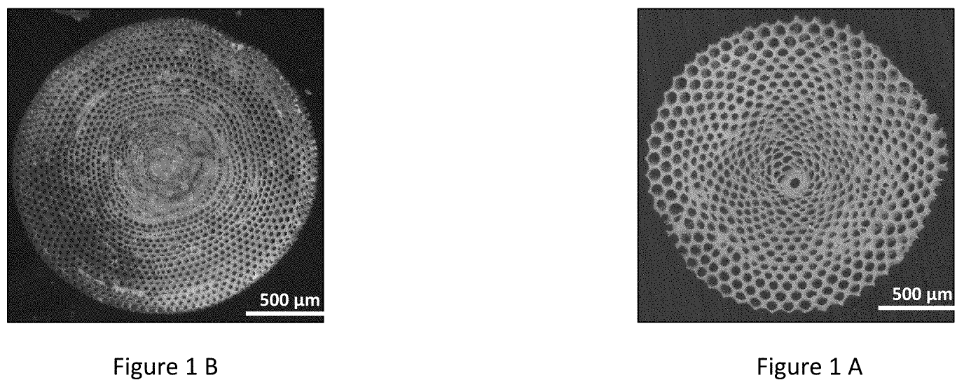

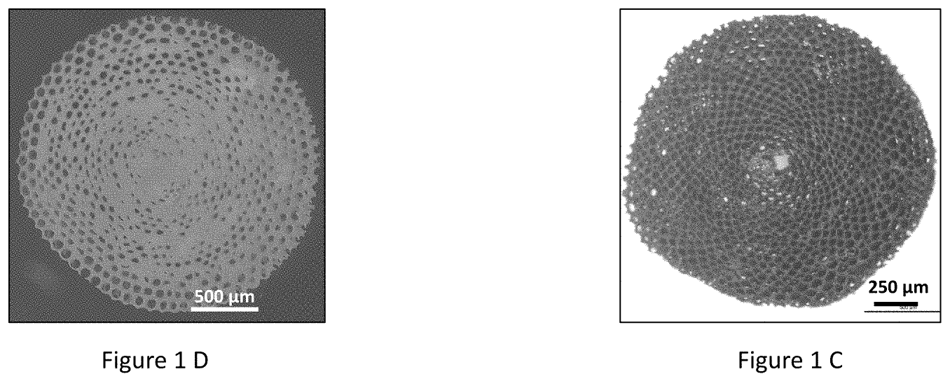

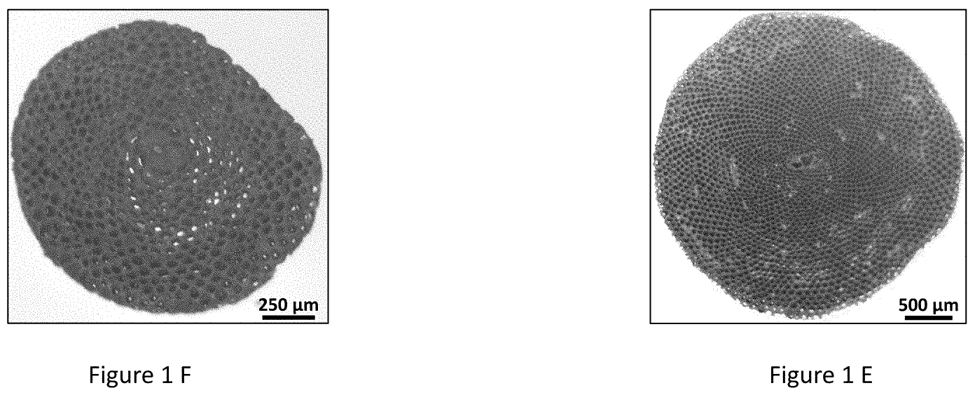

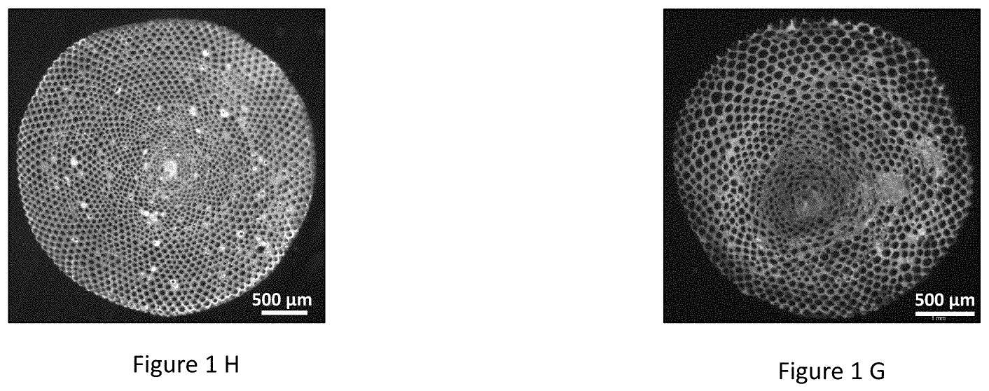

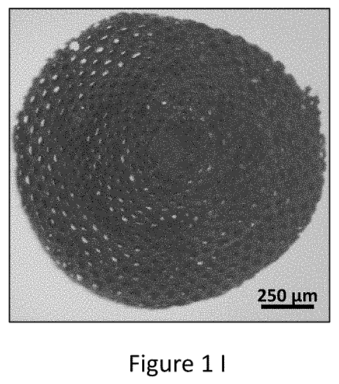

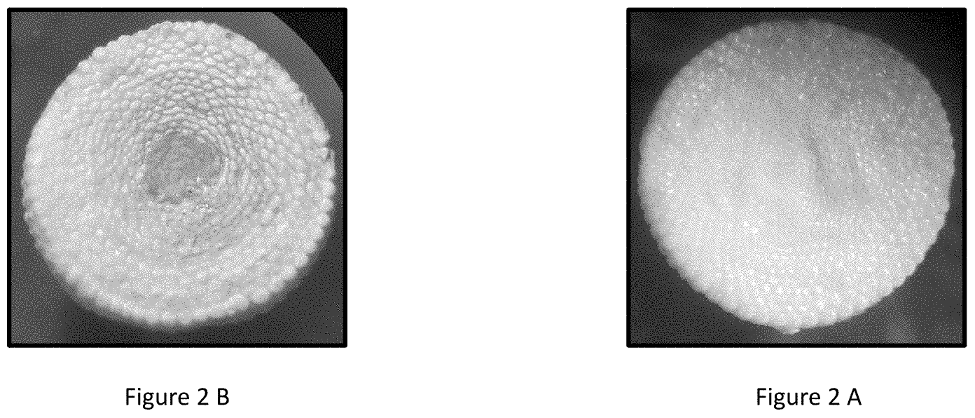

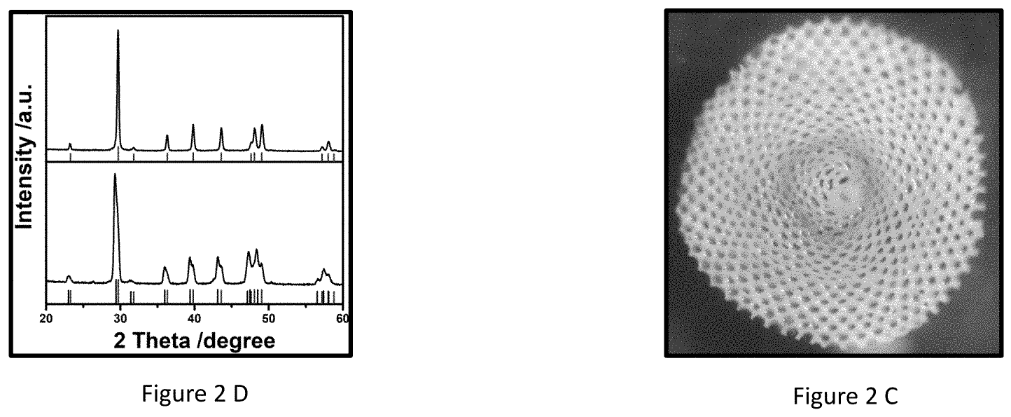

a general and simple approach was used for the growth of unique hierarchical structures which consist of nanofeatures using calcareous foraminiferal shells (CFSs). One of the most compelling aspects of foraminifera is its ability to build to calcareous shells with various morphologies and sizes. In this work, the naturally designed morphologies of the CFS to rationally form hierarchical structures of nanofeatures were harnessed as demonstrated in FIGS. 1A-I. Fourteen different materials with diverse properties were grown on the CFS as shown in FIGS. 1A-I. Sorites was chosen as a case study to demonstrate that the CFS can be used as scaffolds to grow inorganic materials. The use of calcareous foraminiferal shells as scaffolds could be easily expanded for coating organic materials. The procedure for growing nanostructures on Sorites involved partial removal of the outer-shell of the CaCO₃ by first heating the Sorites at 500° C. for 5 hr, followed by transferring them to a solution of HCl 0.05 M for 2-3 min and then washing with water (FIGS. 2A-D). The removal of the outer-shell allows for the grown materials to reach the inner walls and tunnels. Then, the Sorites were placed in different growth solutions for coating with nanostructures as described above.

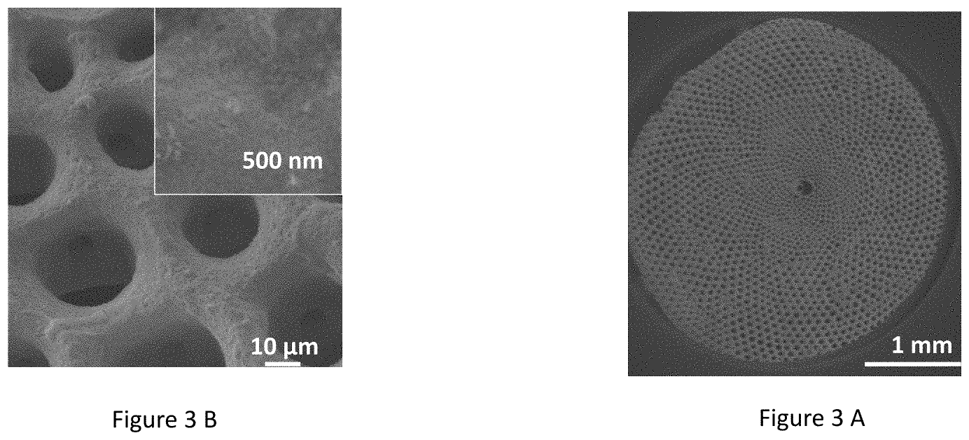

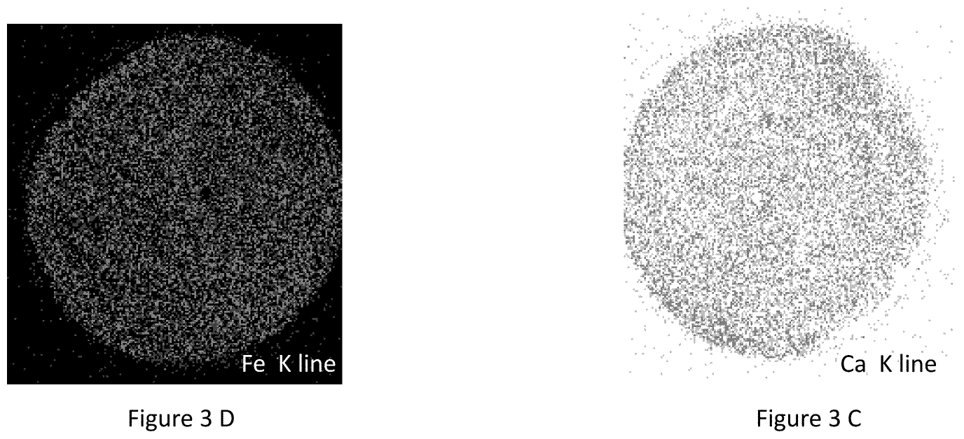

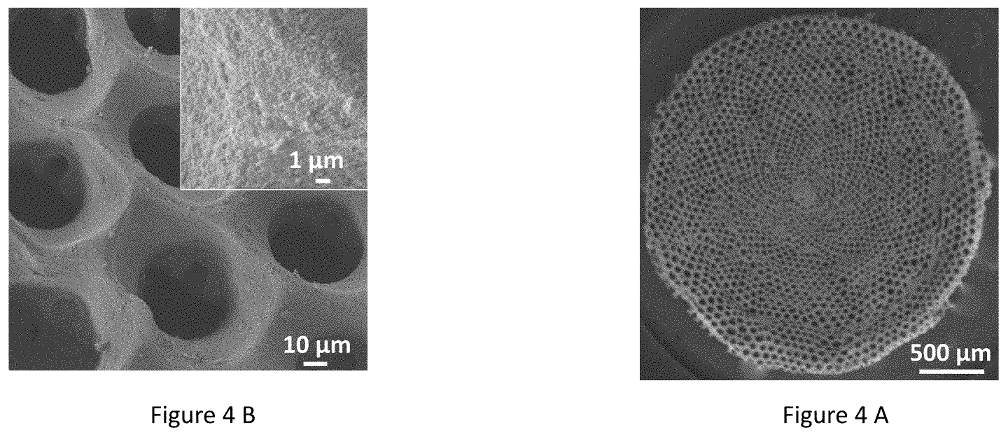

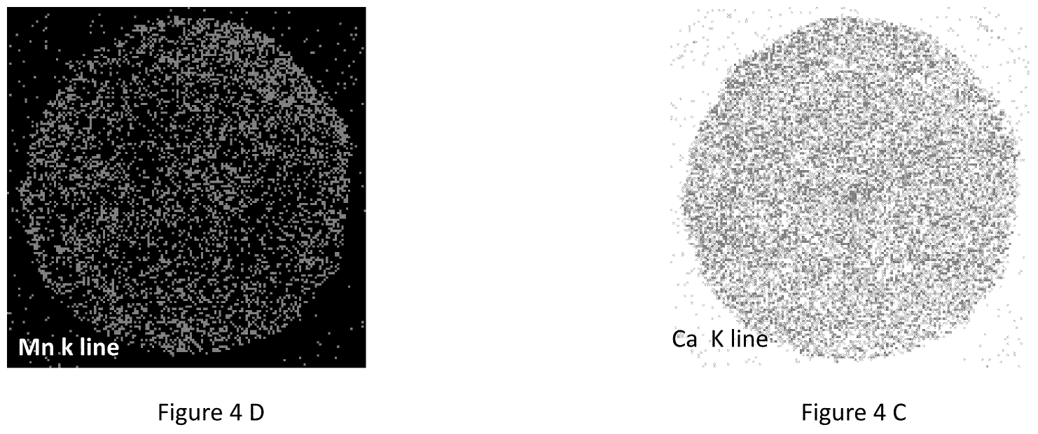

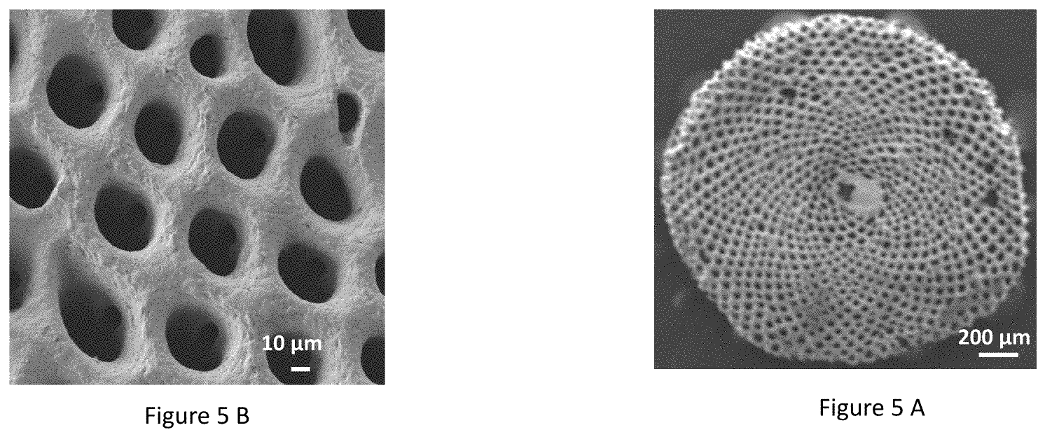

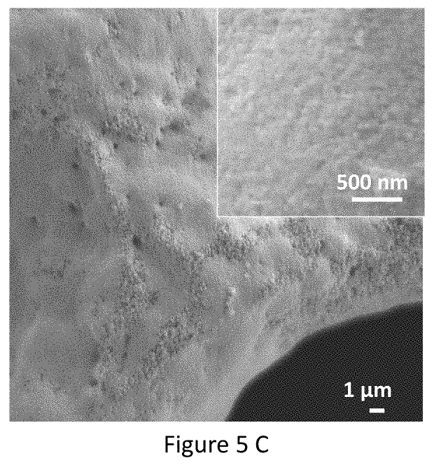

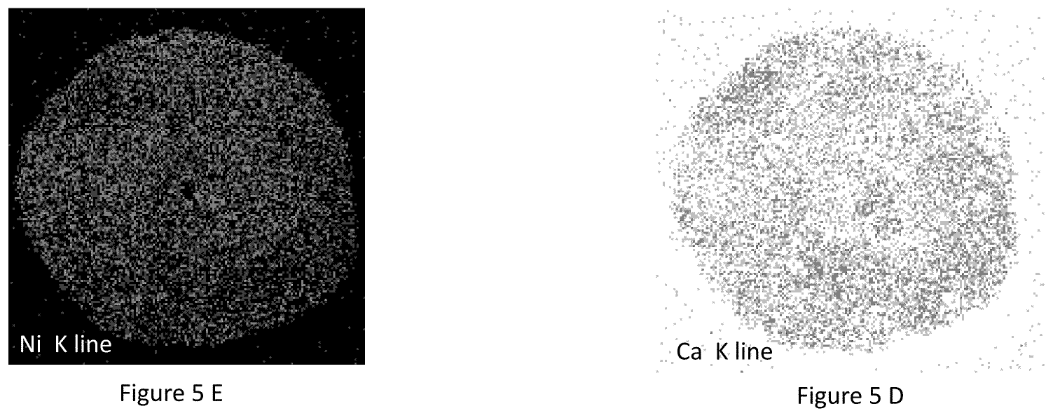

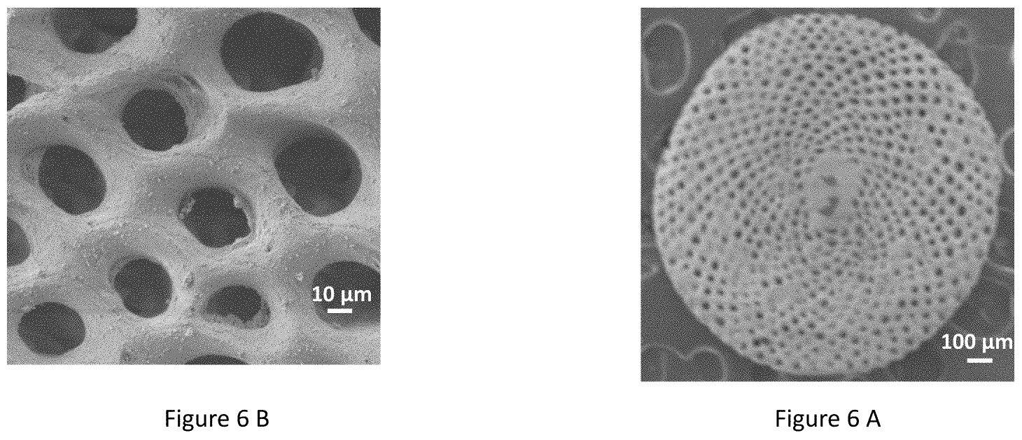

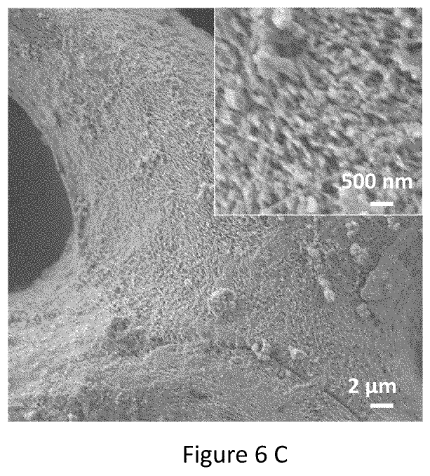

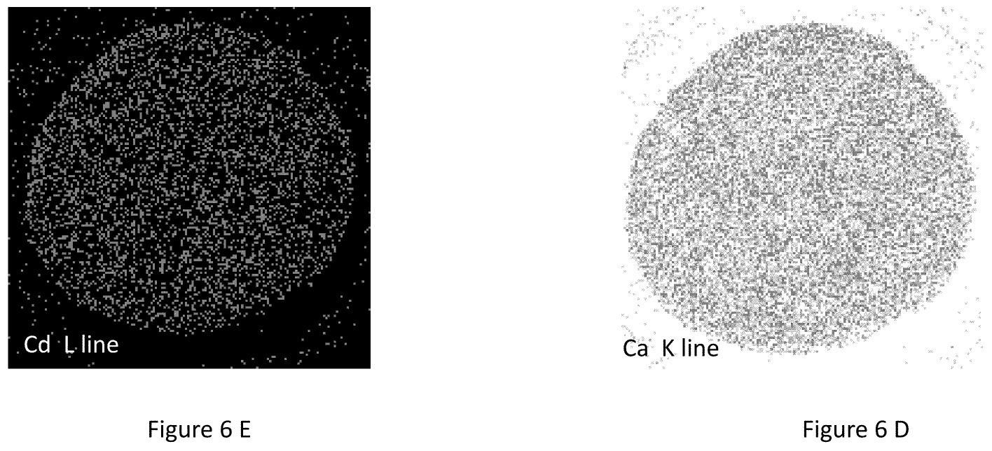

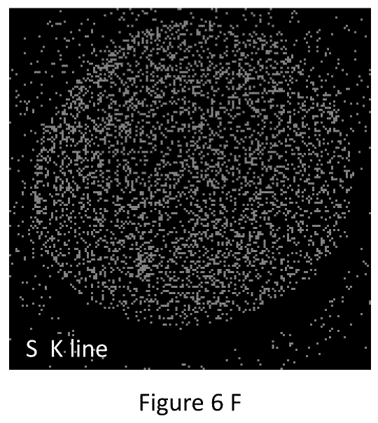

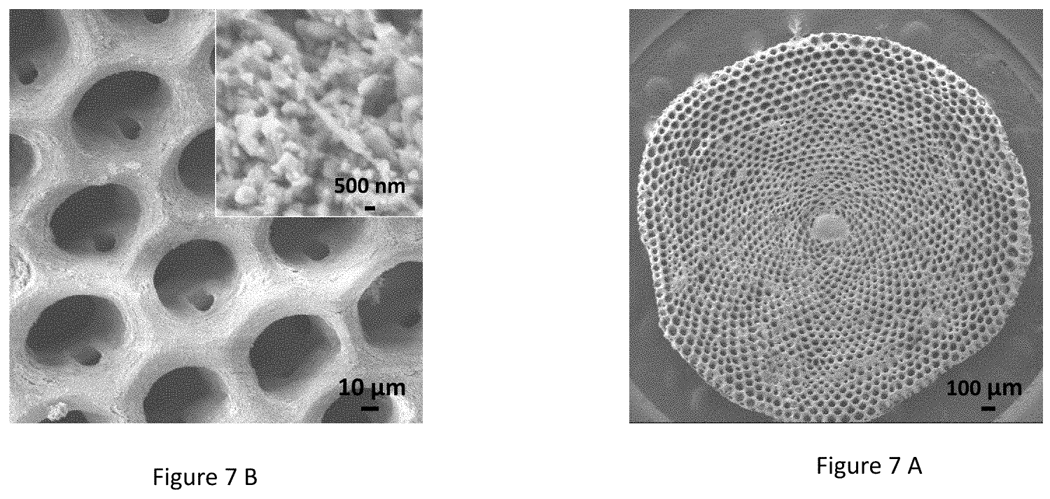

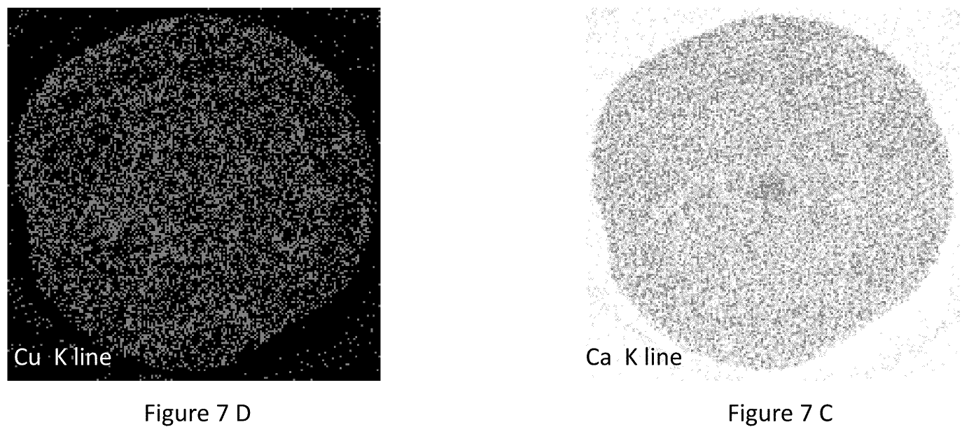

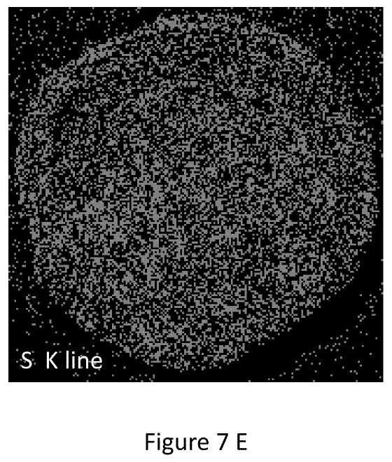

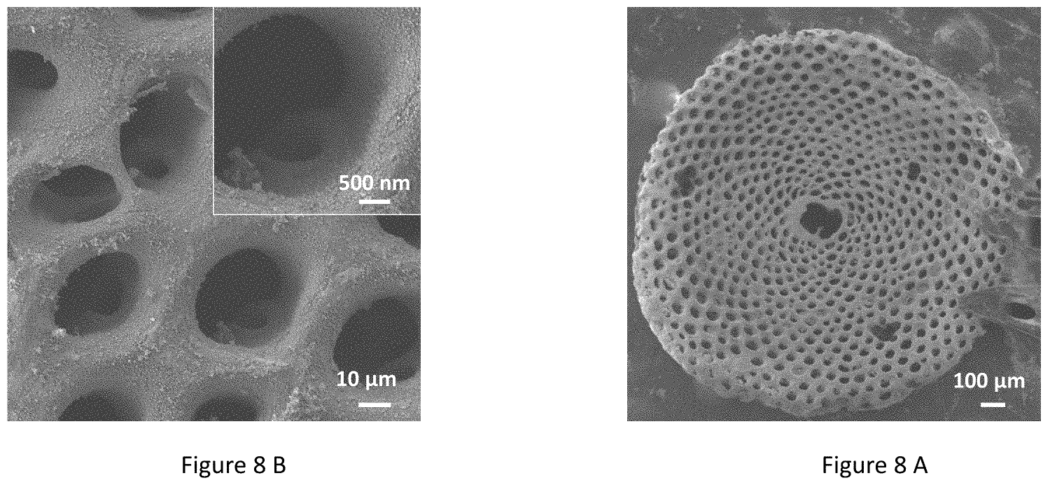

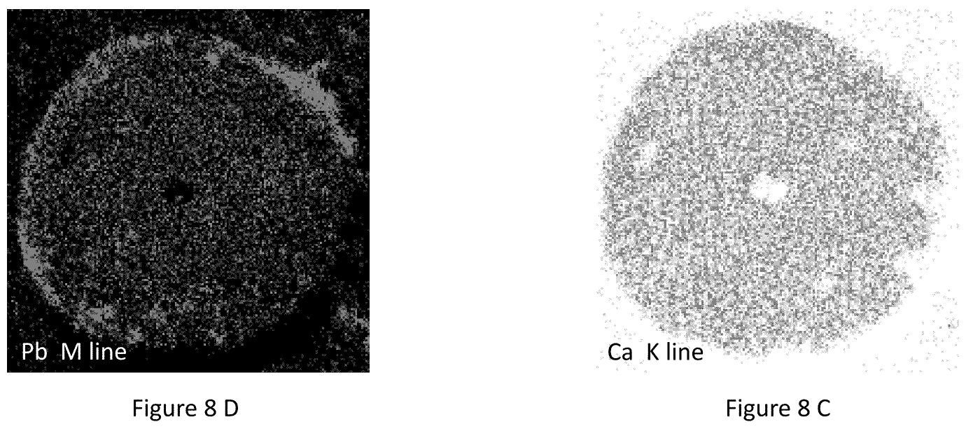

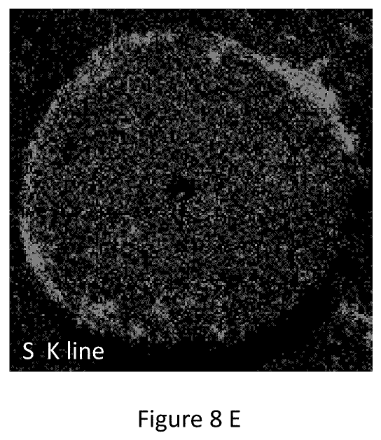

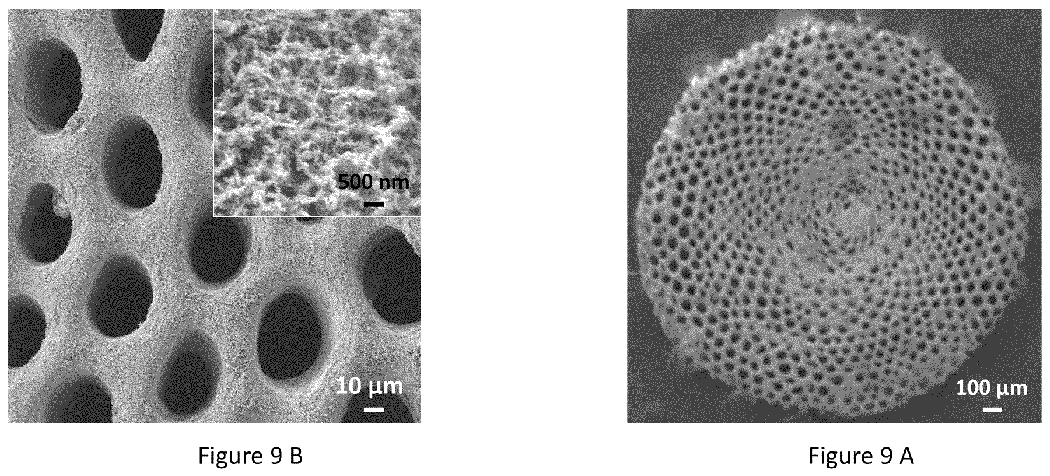

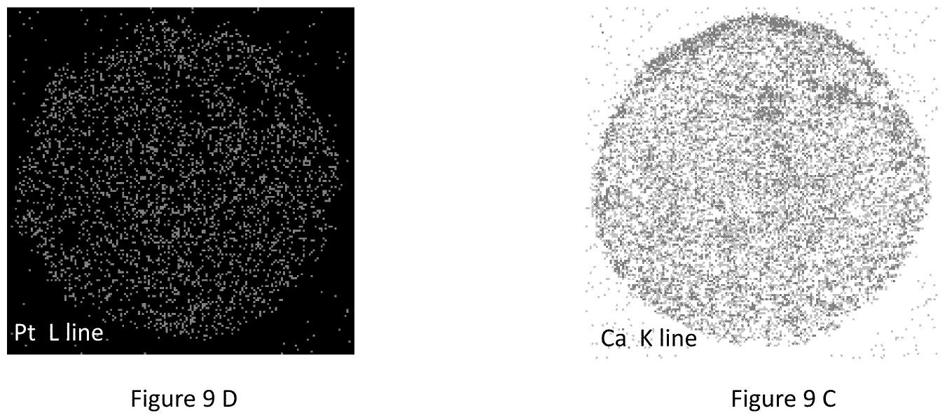

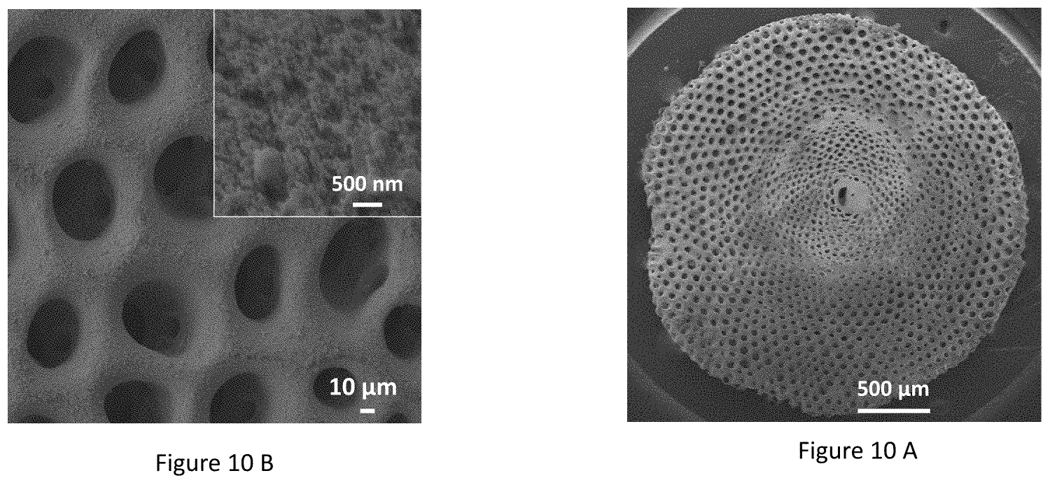

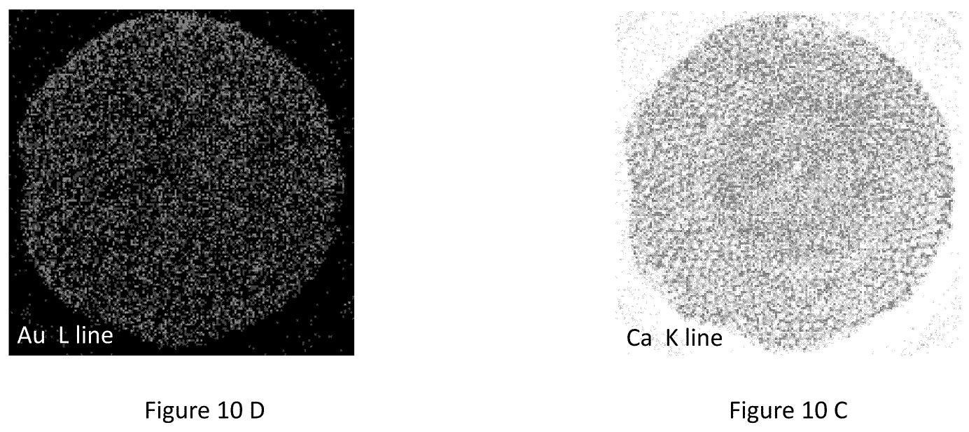

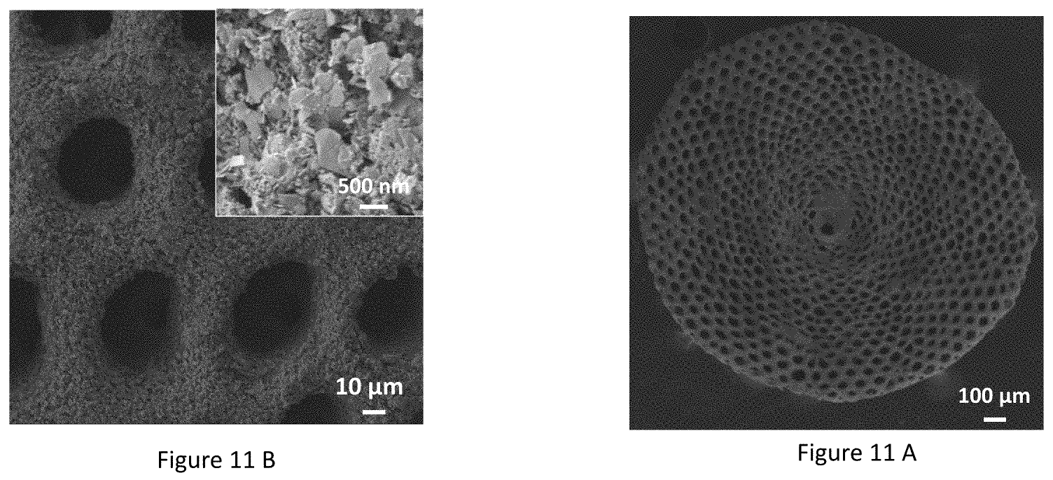

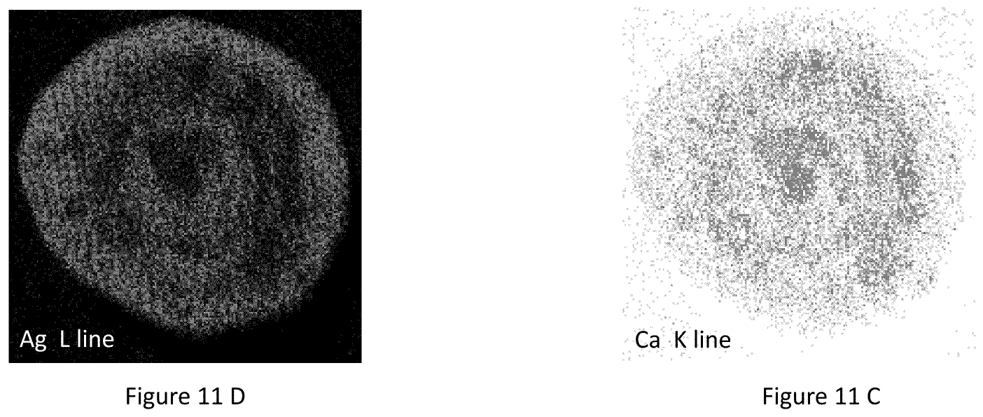

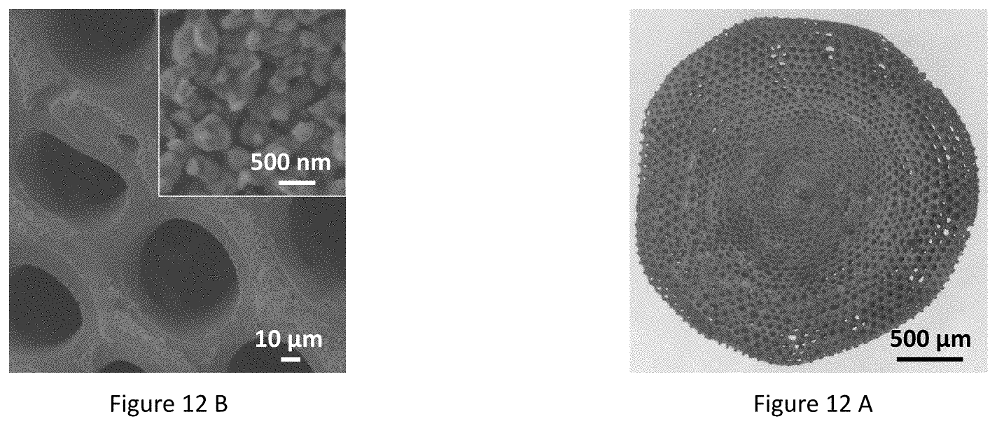

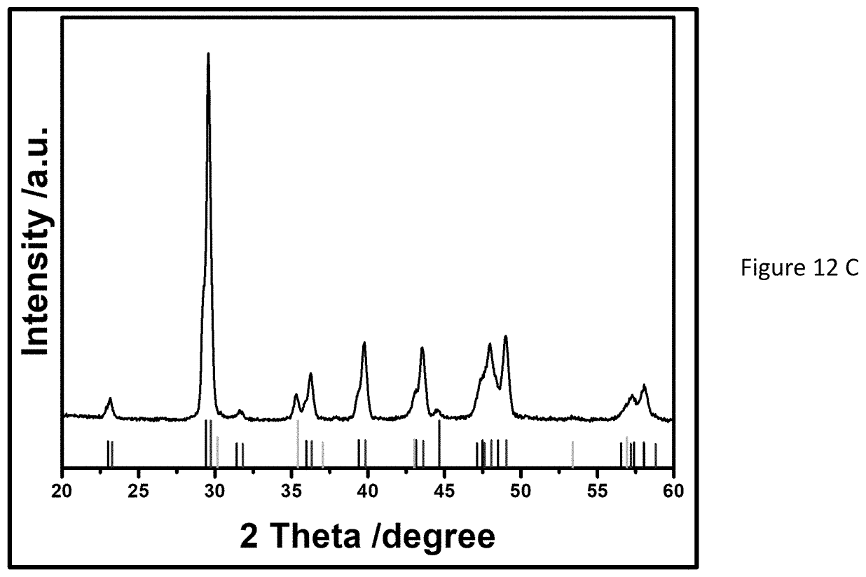

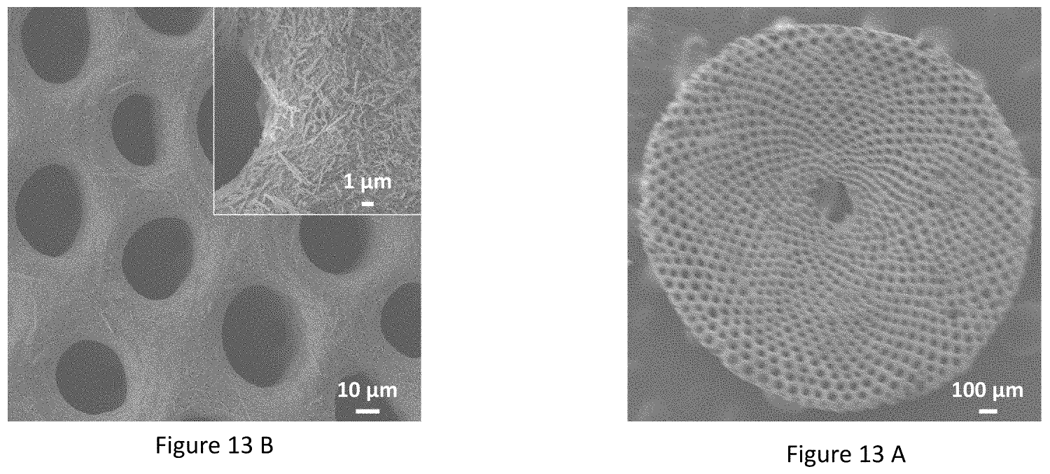

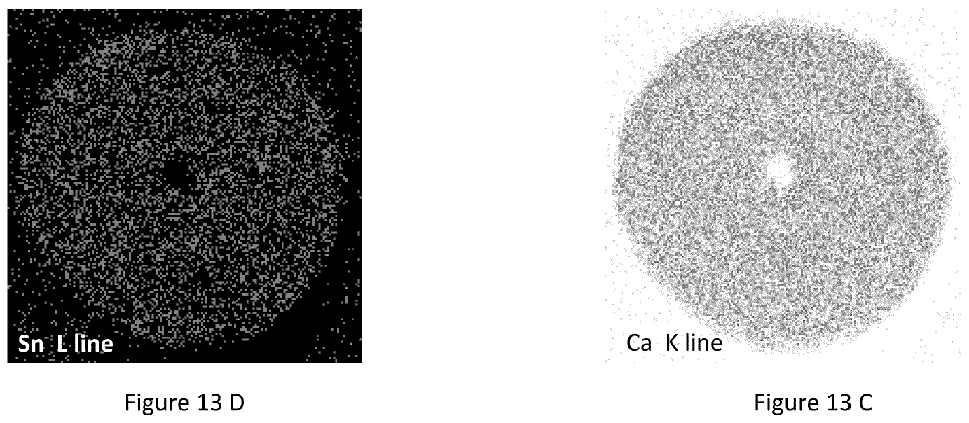

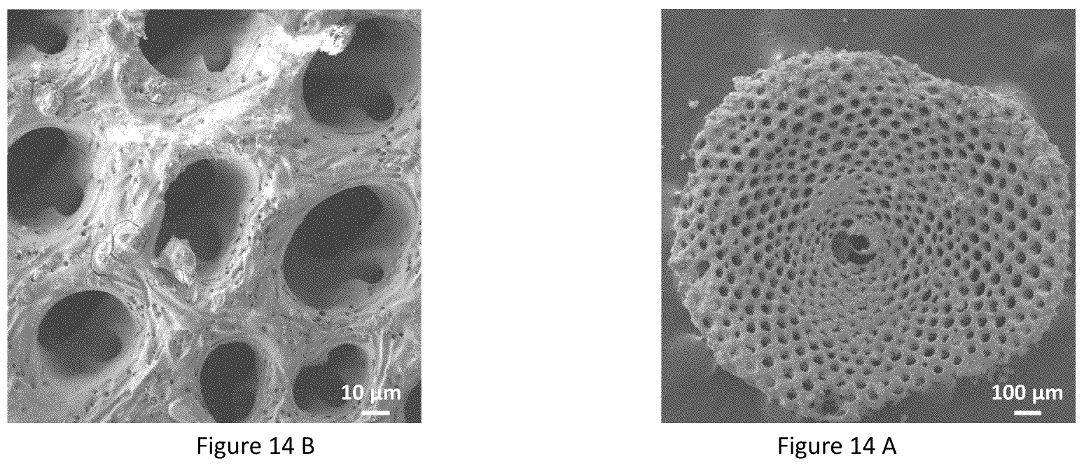

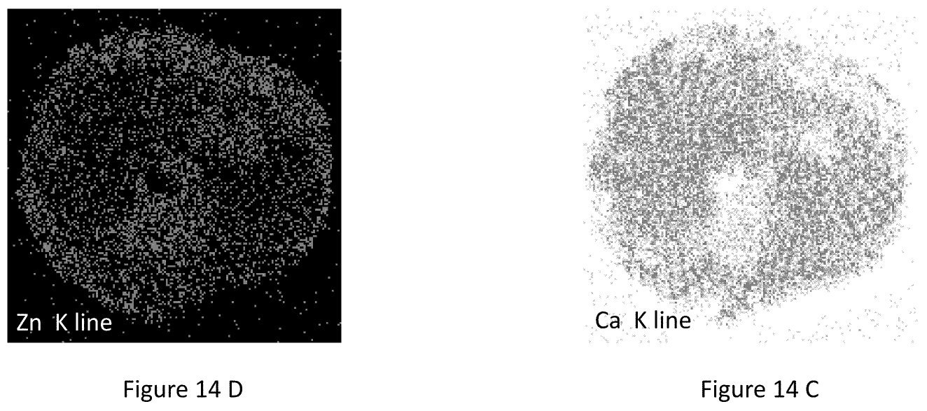

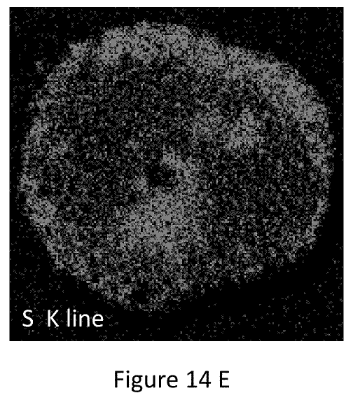

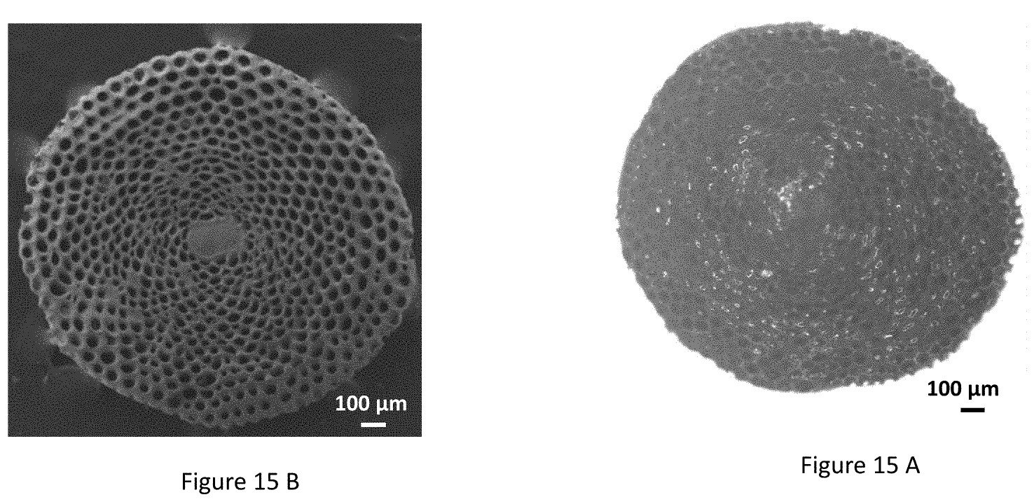

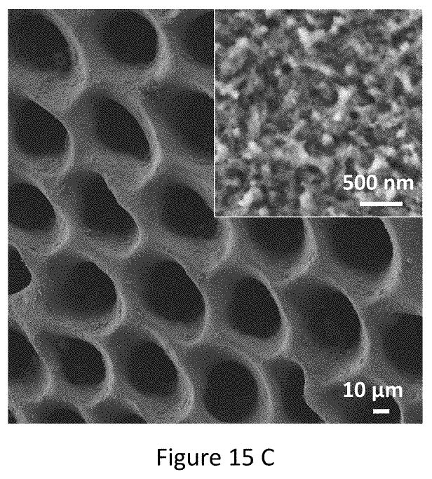

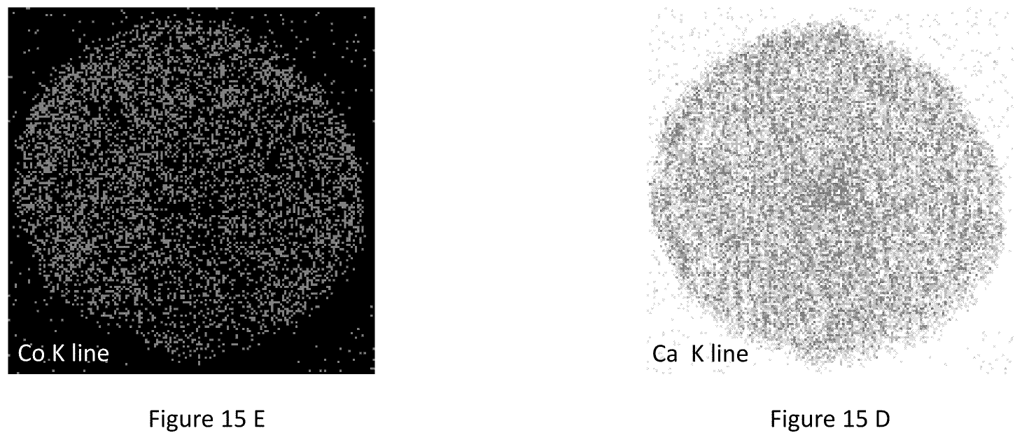

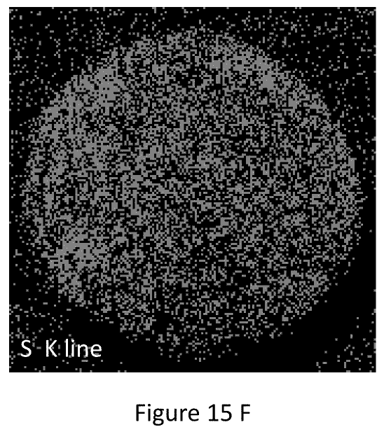

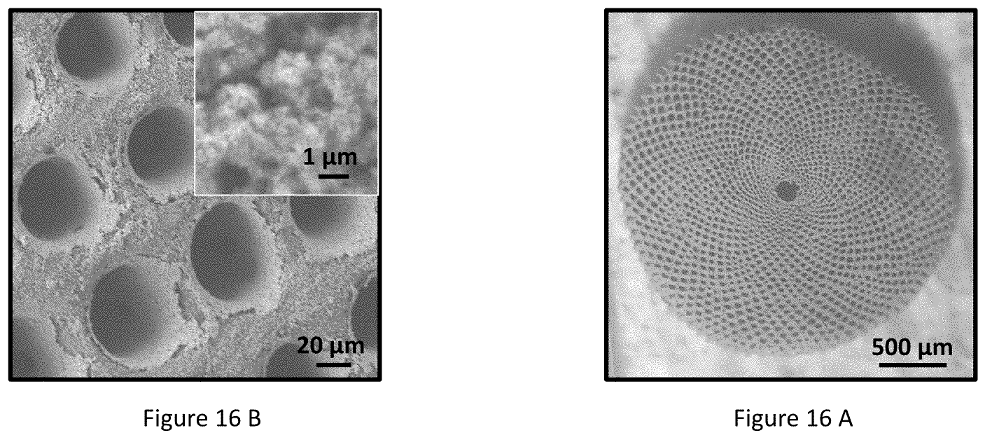

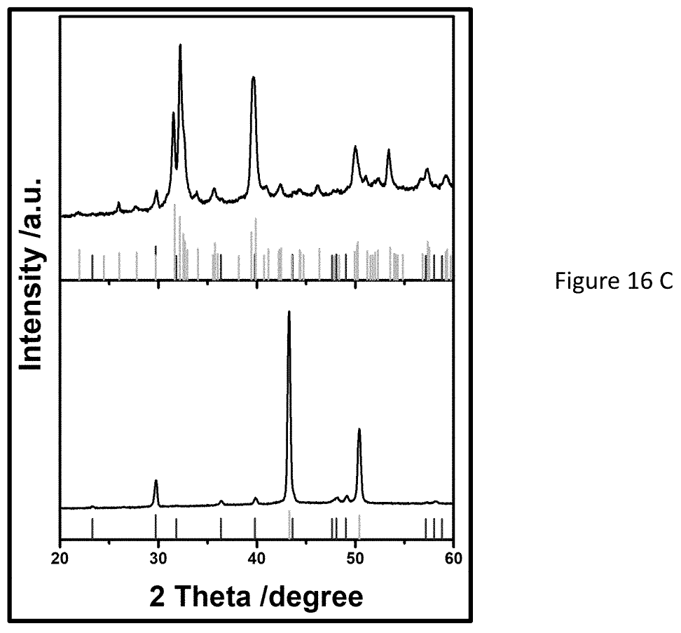

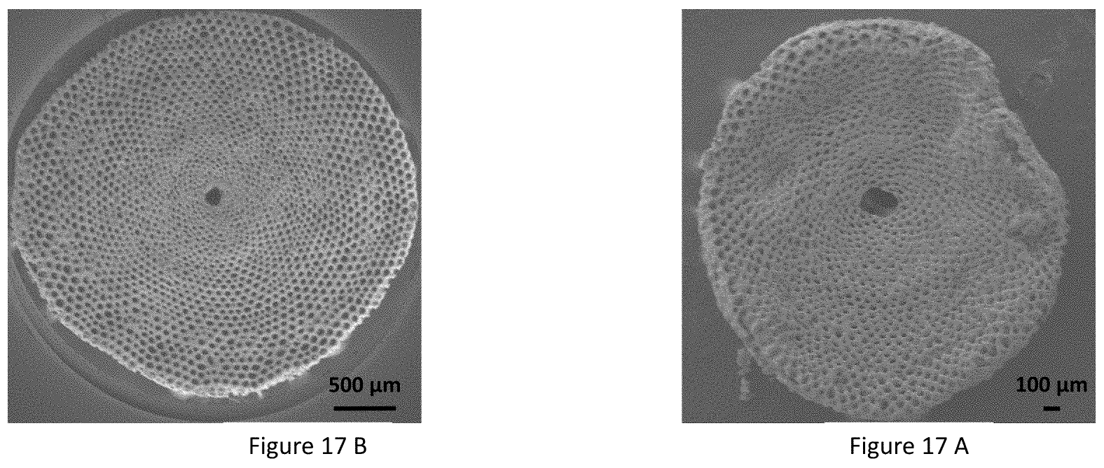

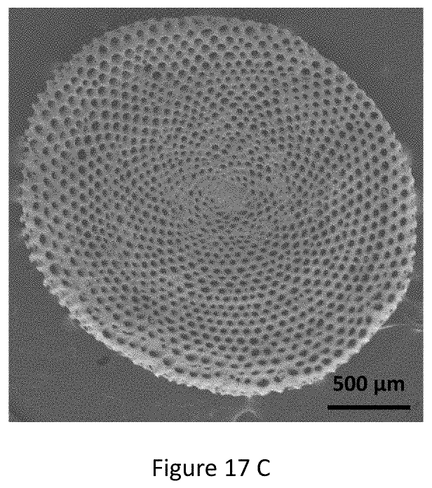

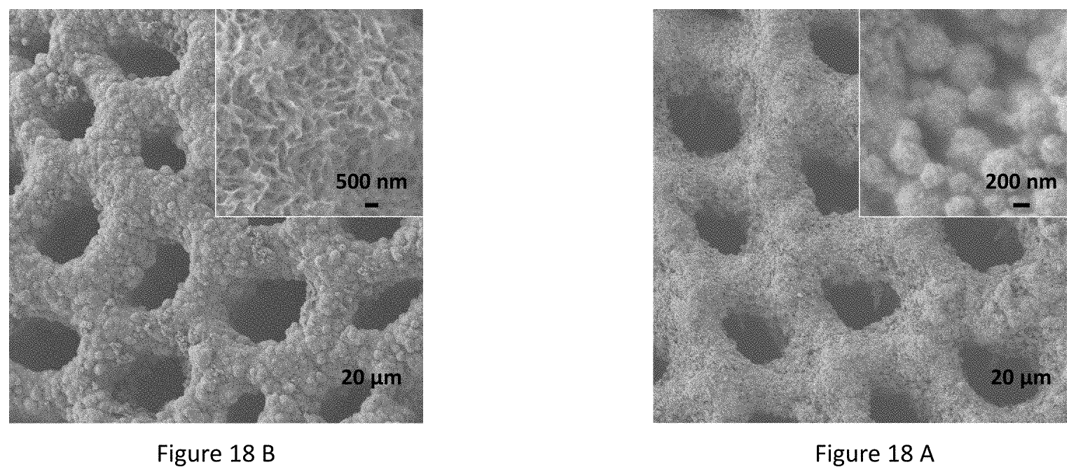

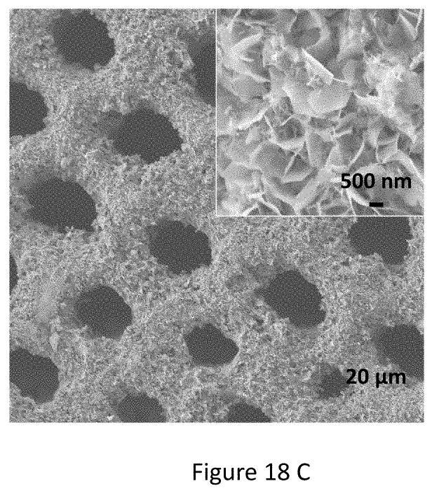

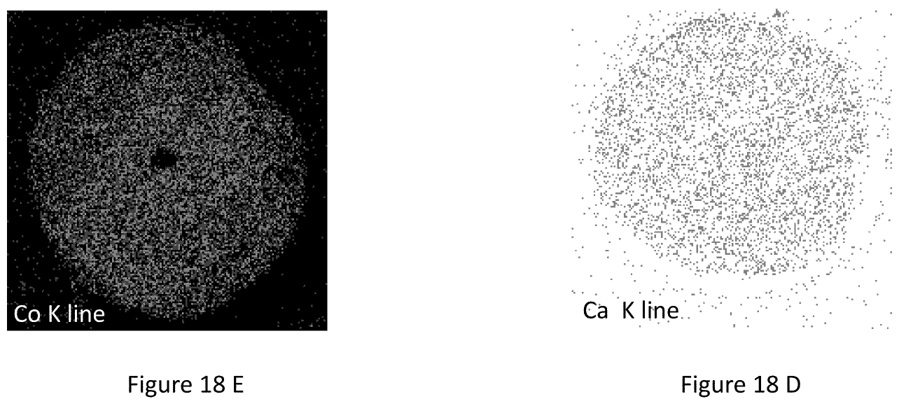

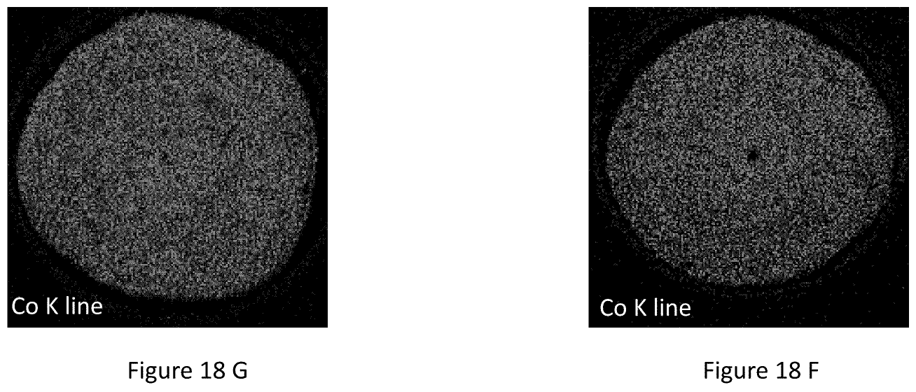

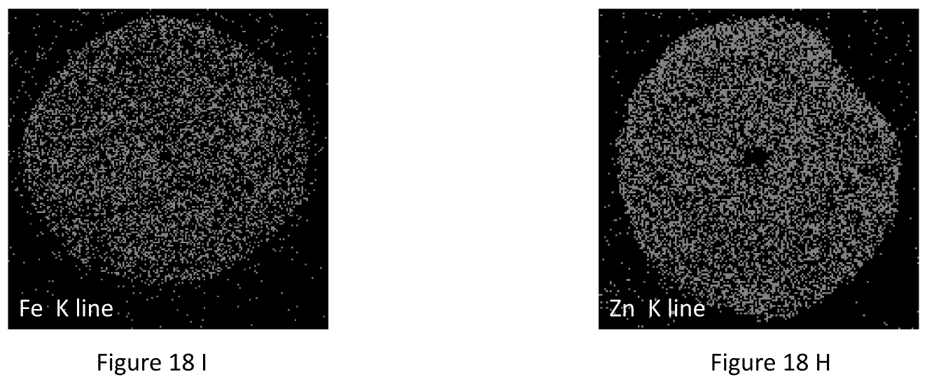

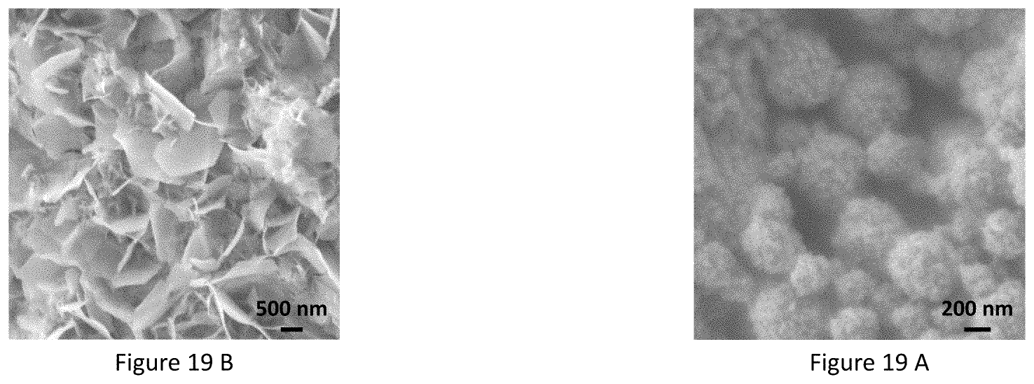

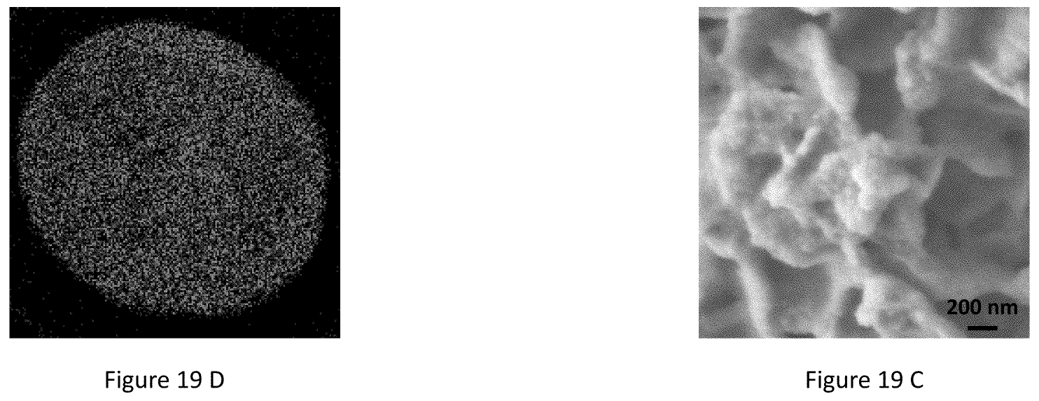

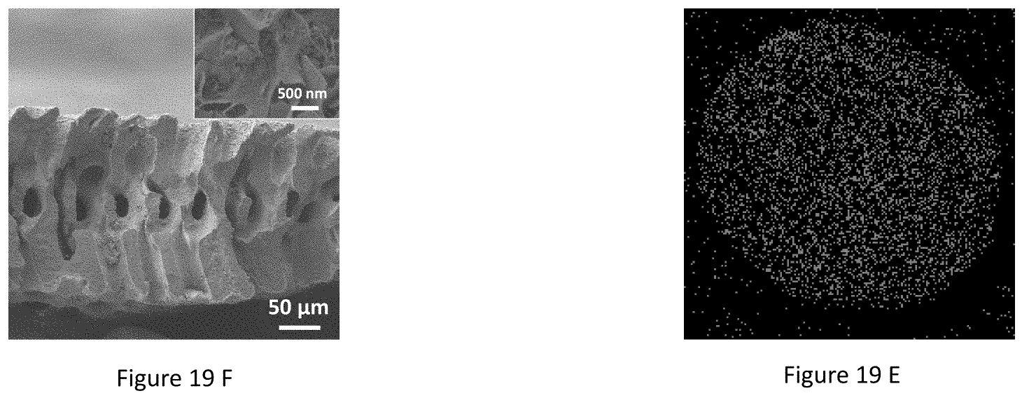

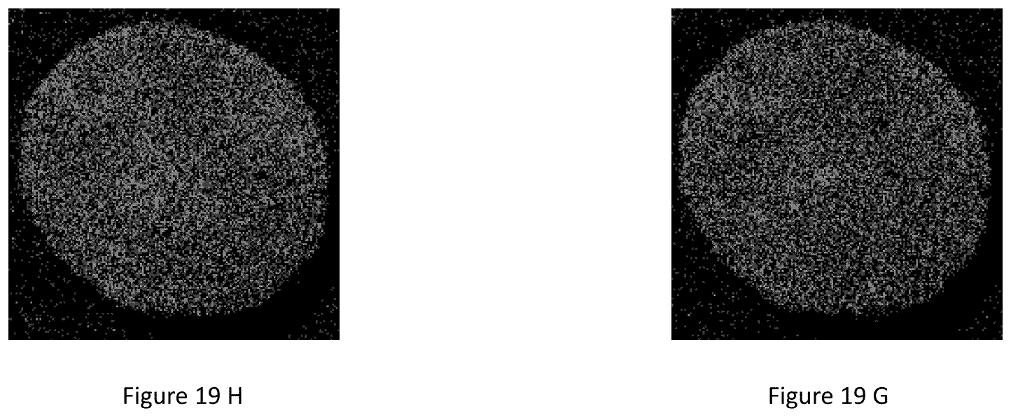

The fourteen inorganic materials were divided to three different groups based on their chemical and physical properties, metal oxide, metal sulphide and noble metals. FIGS. 1A-I present the optical images of sorites coated by Fe₂O₃ (FIGS. 1A and 3A-D), MnO (FIGS. 1B and 4A-D), NiO (FIGS. 1C and 5A-E), CdS (FIGS. 1D and 6A-F), Cu₂₋ₓS (FIGS. 1E and 7A-E), PbS (FIGS. 1F and 8A-E), Pt (FIGS. 1G and 9A-D), Au (FIGS. 1H and 10A-D), Ag (FIGS. 1I and 11A-D), Fe₃O₄ (FIGS. 12A-C), SnO (FIGS. 13A-D), ZnS (FIGS. 14A-E), CoS (FIGS. 15A-F) and Cu (FIGS. 16A-B). The homogenous coating of the sorites with different materials enables controlling the thickness of the coated materials from few monolayers to few tens of nanometers. Furthermore, a more complex structures can be attained by growing multiple layers of different types of materials as shown in FIGS. 17A-C, 18A-C and 19A-H. Three different combinations of two and three materials were achieved: Sorites@Co@ZnO (FIG. 17A and FIG. 18B), Sorites@Co@FeOOHₓ (FIG. 17B and FIG. 18C) and Sorites@Co@FeOOHₓ@CdS (FIG. 17C and FIG. 19A-H). The growth of multiple layers was verified by Energy-dispersive X-ray spectroscopy (EDX) mapping shown in FIGS. 18 D-I and FIGS. 19 (D, E, G and H). The EDX mapping confirms that the multiple materials were y grown successful on the template.

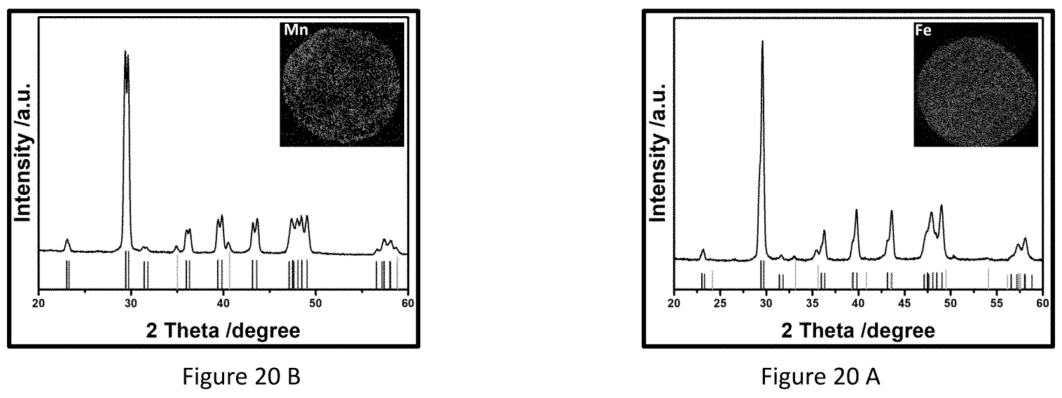

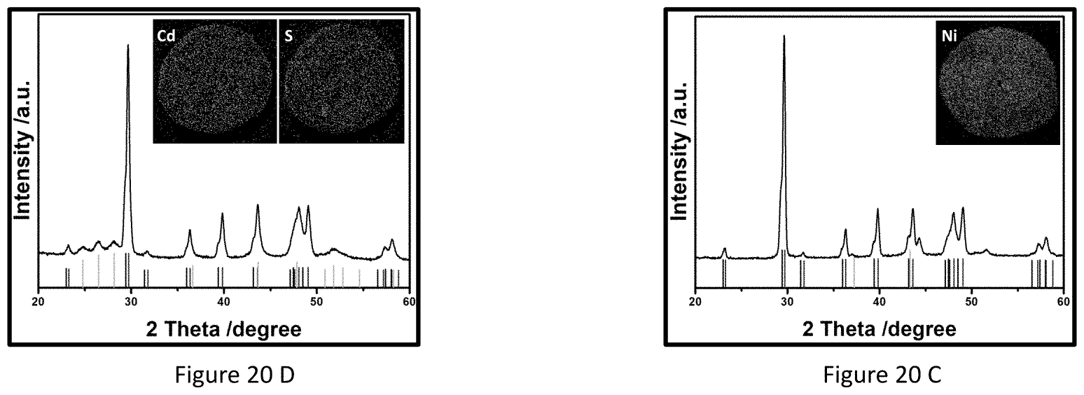

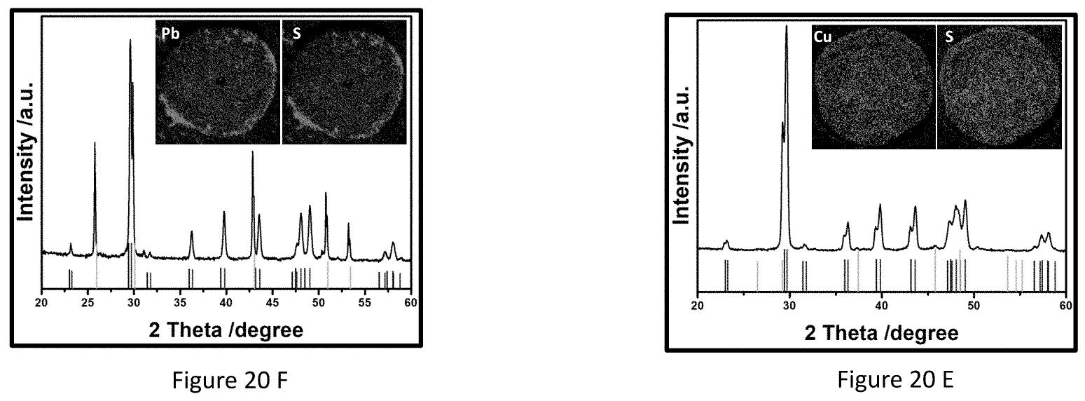

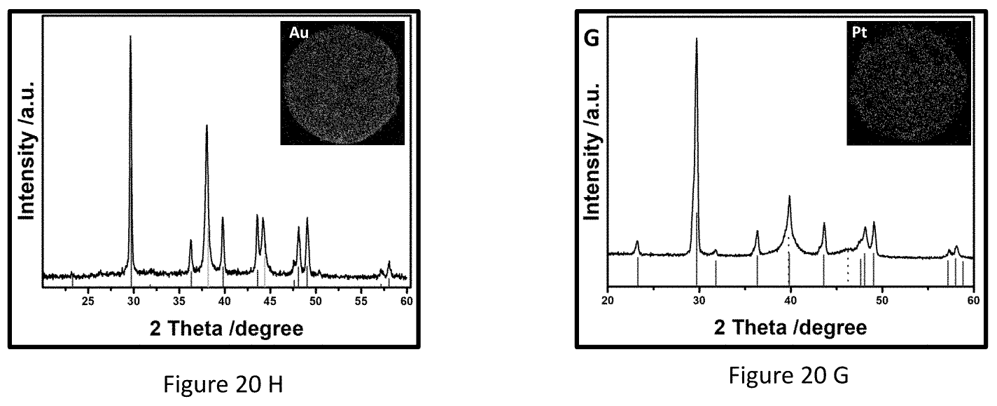

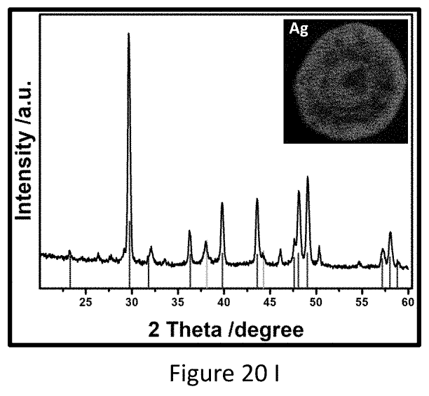

The homogeneity of the coating in all the samples shown in FIGS. 1A-I was confirmed by conducting structural characterization of the products using EDX mapping and X-ray diffractions as presented in FIGS. 20A-I. All the samples show that all the coated materials are crystalline and clear peaks of the CaCO₃ and the coated materials were observed. The crystal structures of the Fe₂O₃, MnO, NiO, PbS, Cu₂₋ₓS, Pt, Au and Ag matches with the face-centered cubic (fcc) structures of the bulk and the CdS pattern matches the wurtzite structure.

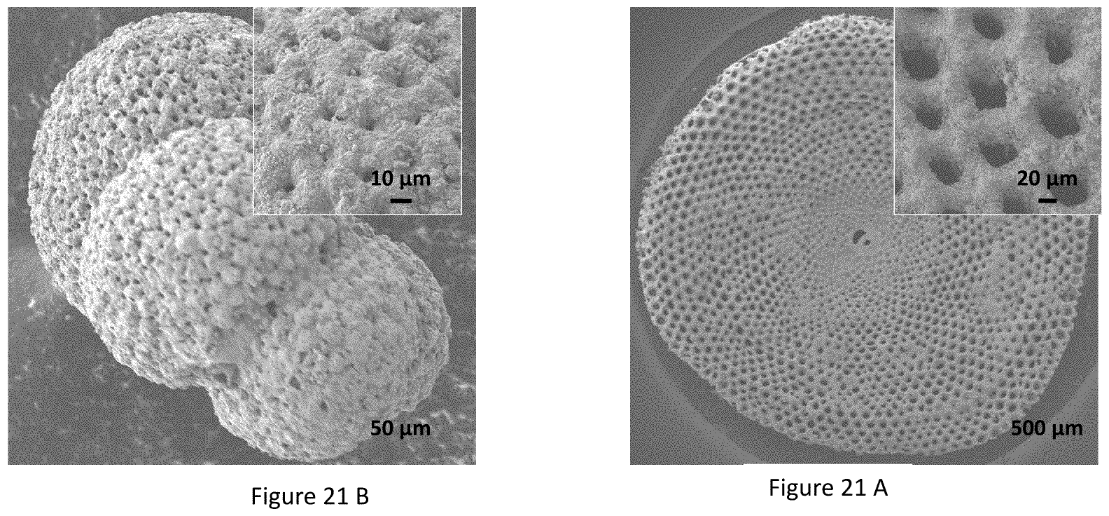

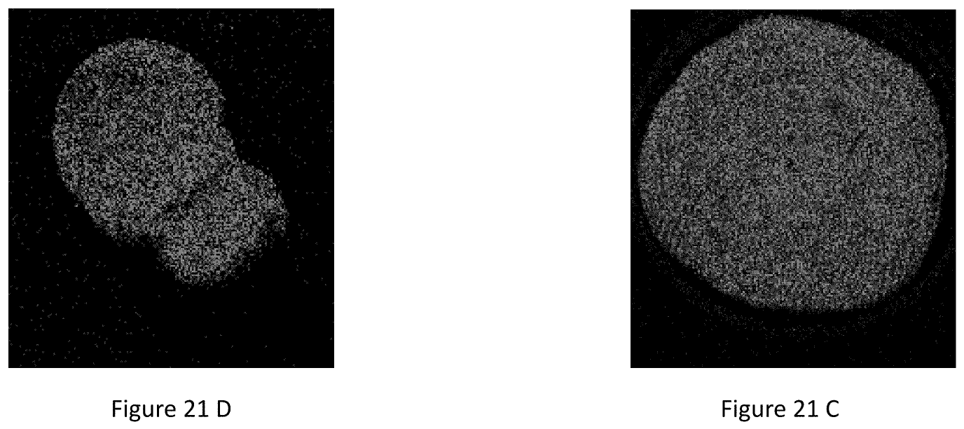

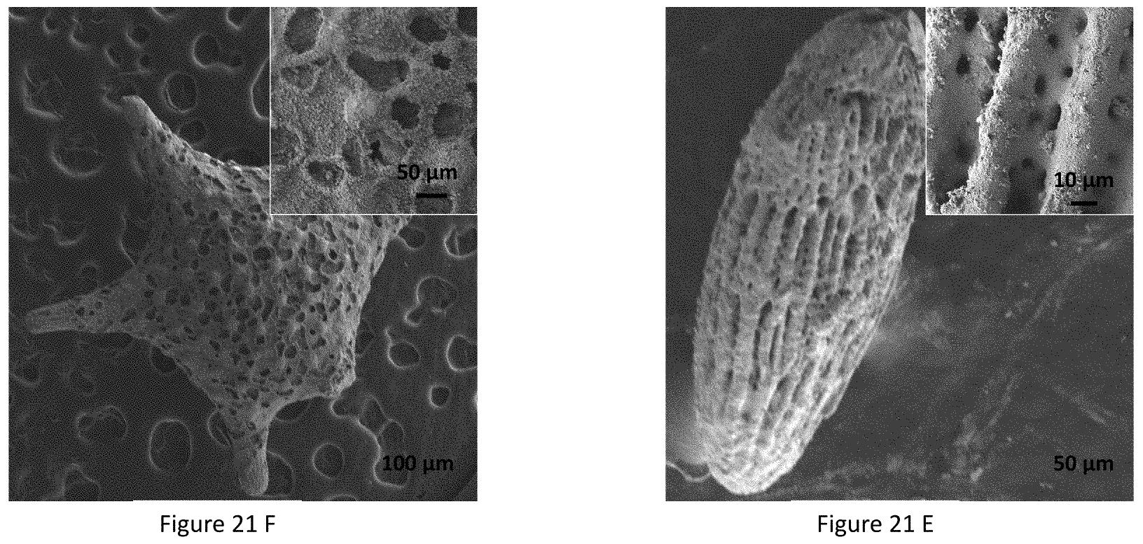

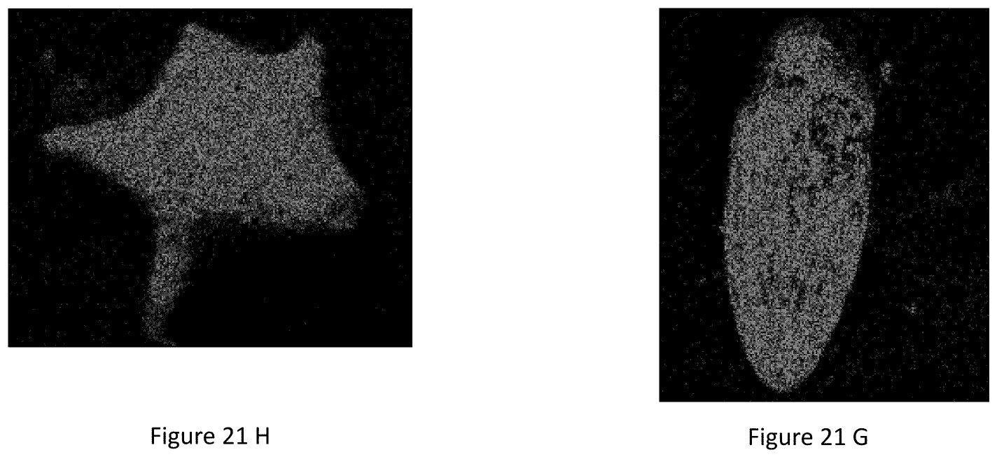

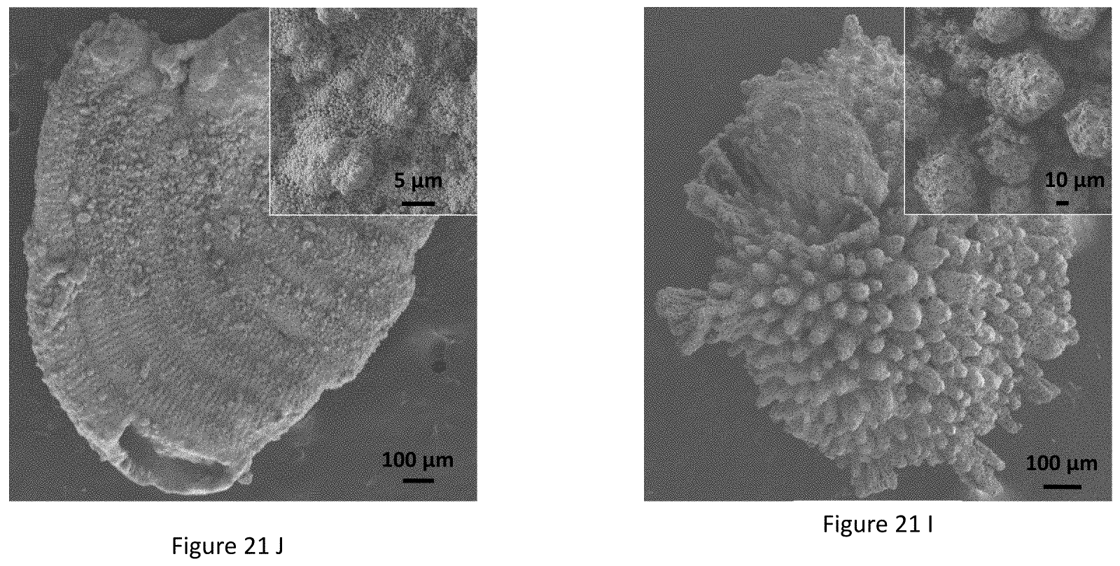

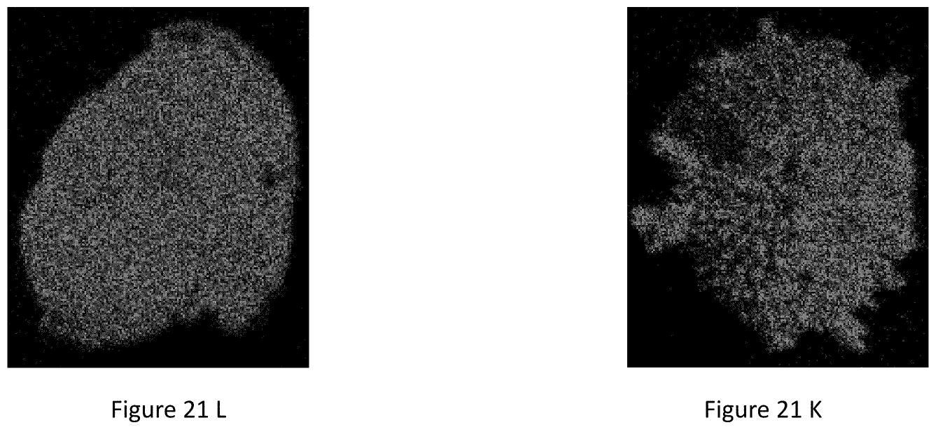

FIGS. 21A-L presents the growth of Co nanostructures on various geometries of calcareous foraminiferal shells according to the procedure described in the experimental section. First, different morphologies of calcareous shells are immersed in solution of sodium hypochlorite 12% and sonicated for few seconds to clean any sediment from the surface or the porous. Next, the shells were transferred to the growth solution containing of the Co materials has been carried out in solution using 40 mg/ml Co(ac)₂ in HDA and they were heated at 300° C. for 30 min and then washed with hexane. This procedure was repeated twice.

A conformal coating of Co nanostructures on the surface of the calcareous shells was achieved as shown in FIG. 21A-L. The thickness of the Co shell can be controlled by the concentration of the Co salt or by conducting a multiple growth cycles in fresh solutions of Co. The quality and the homogeneity of the coating can be observed in the HRSEM image of Co materials as shown in FIG. 21A.

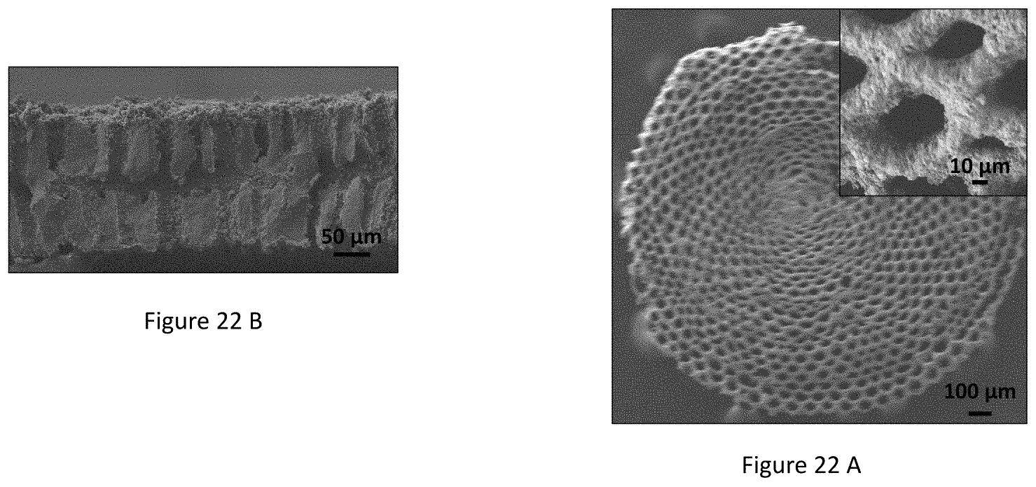

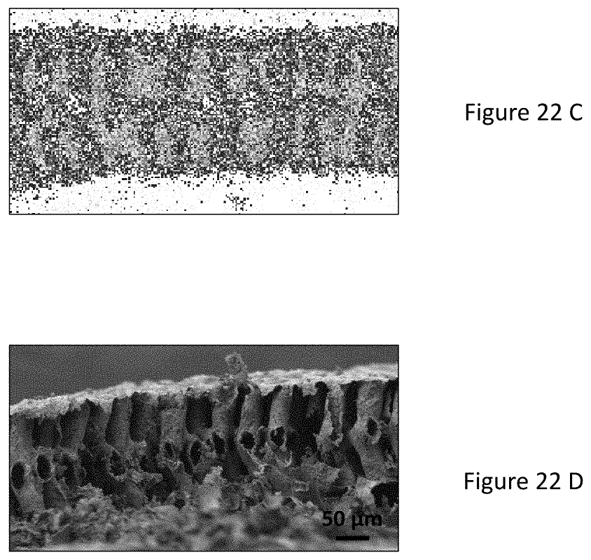

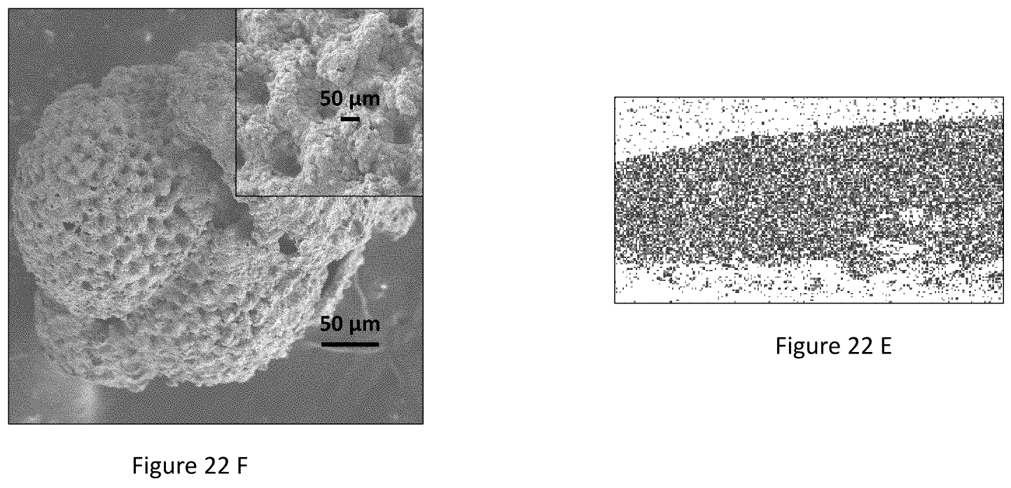

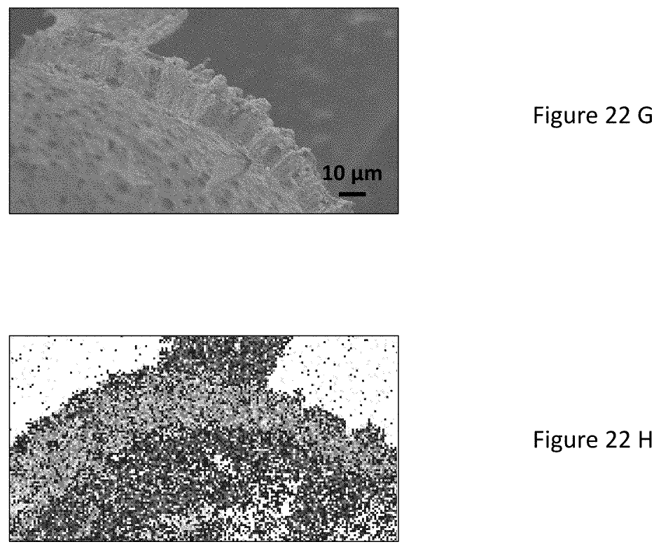

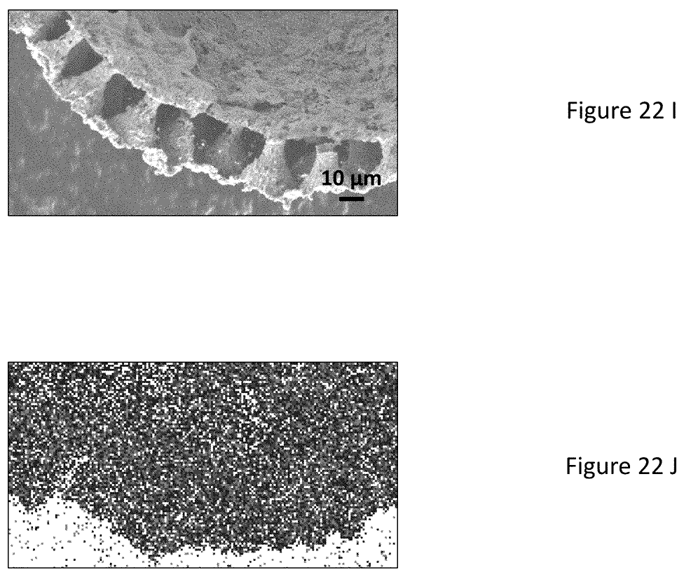

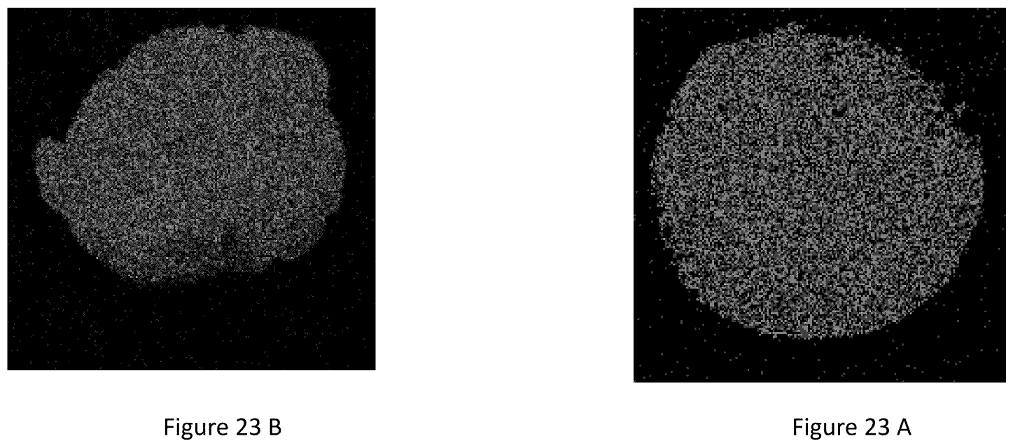

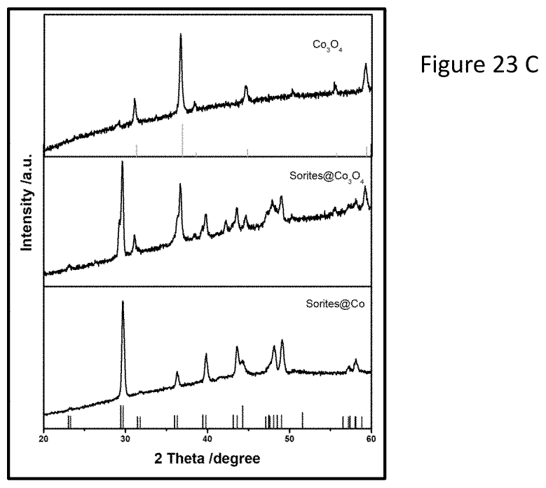

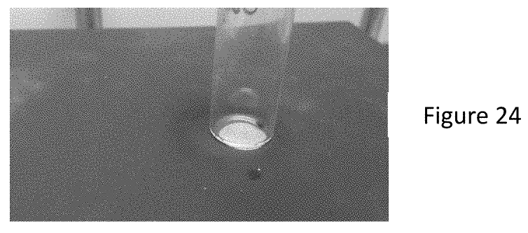

One of the most appealing advantages of using scaffolds to grow various materials is the ability to remove the template while preserving the same morphology. The removal process of the template on two different morphologies of the calcareous foraminiferal shells, sorites and Globigerinella siphonifera was tested after their coating by thick layer of Co materials. The removal of the template was carried out by first annealing the samples and converting the Co to Co₃O₄ to provide additional stability and then immersing the sorites@Co₃O₄ sample in HCl solution (0.1 M) for (20 minutes) and followed by washing it with distilled water. FIGS. 21A-L, and 22A-J show the etching process of the CaCO₃ template coated by Co₃O₄ materials before (FIGS. 21A and B) and after (FIG. 22A and FIG. 22F) the removal of the CaCO₃; FIGS. 22B and 22D vis-a-vis FIGS. 22G and I show the SEM images of cross section before and after the etching process, respectively. It was shown that the hierarchical structures of the two samples were preserved after removing the template. The removal of the CaCO₃ in the two samples was verified by EDX mapping where before etching the Ca and Co signals are shown in FIGS. 22C and 22H and after etching the Ca signals disappear and only Co signals were detected as presented in FIGS. 22E and 22F. Moreover, the removal of the template was also confirmed by XRD, where the CaCO₃ peaks disappear after it was etched and only Co₃O₄ peaks were obtained as shown in FIG. 23C. The sorites@Co presents magnetic properties as shown in the movie (snapshot shown in FIG. 24). The etching process could be expanded to other inorganic materials that are stable in acidic solution.

Besides the assembly and the unique morphologies of the 3D structure, a high surface area is another feature. Measuring the surface area of the Sorites using Brunauer-Emmett-Teller theory (BET) shows a 5.26 m²/g. This value is considered high compared to the surface area of the used biological templates (1.4-51), especially without any kind of treatments to the surface. Furthermore, coating the Sorites with Co increases the surface area of the 3D structure by 3 times (17.25 m²/g).

The two properties of the high surface area combined with the 3D morphology pave the way for using the Sorites in several applications. In this work, the focus was the potential application of the prepared 3D structure in electrocatalyic water oxidation process using Sorites@Co and in water purification process for removing heavy metals and generally various metal cations using Sorites, e.g., Sorites@CdS.

To investigate and exploit the ability of the hierarchical structures of inorganic nanomaterial (HSIN) in removing containments from water and water oxidation process, the Sorites were coated with various inorganic materials and were tested in those two processes.

Water Oxidation.

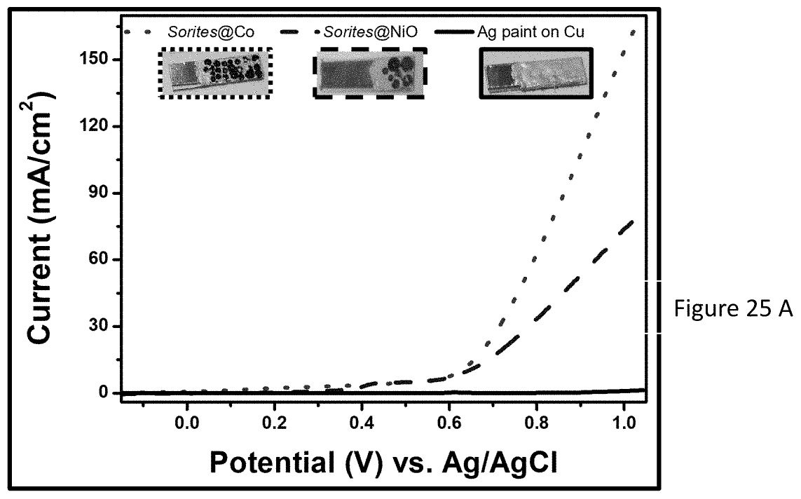

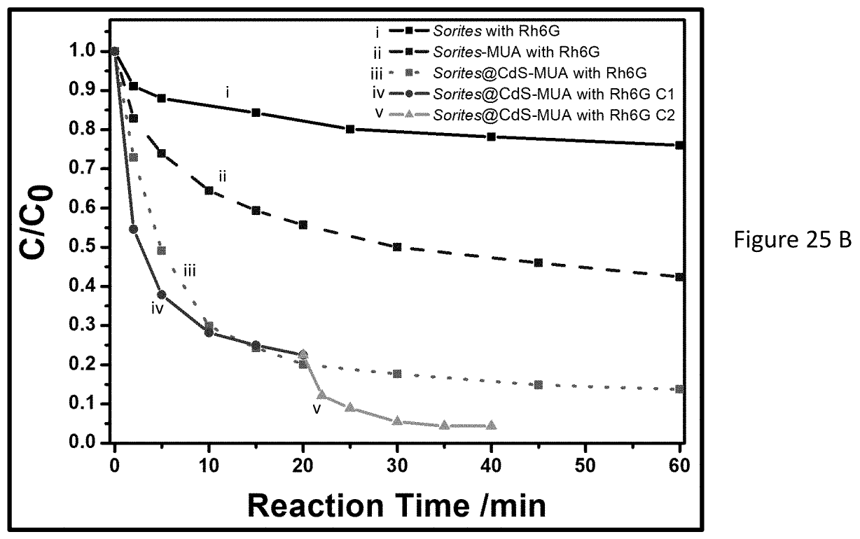

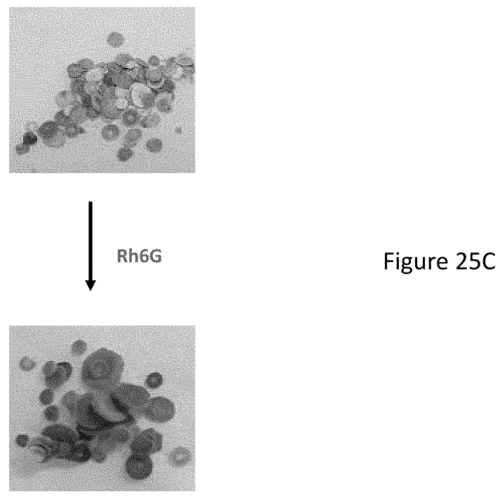

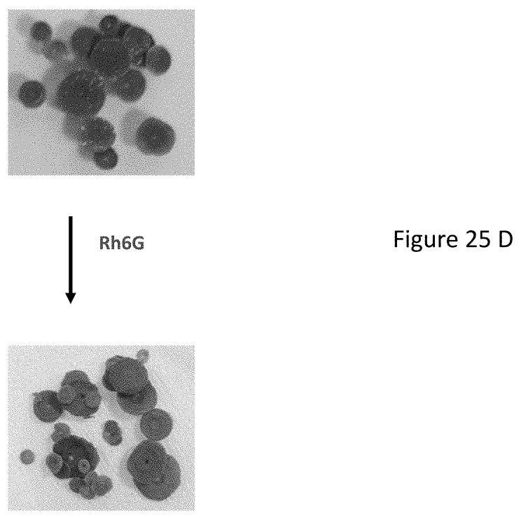

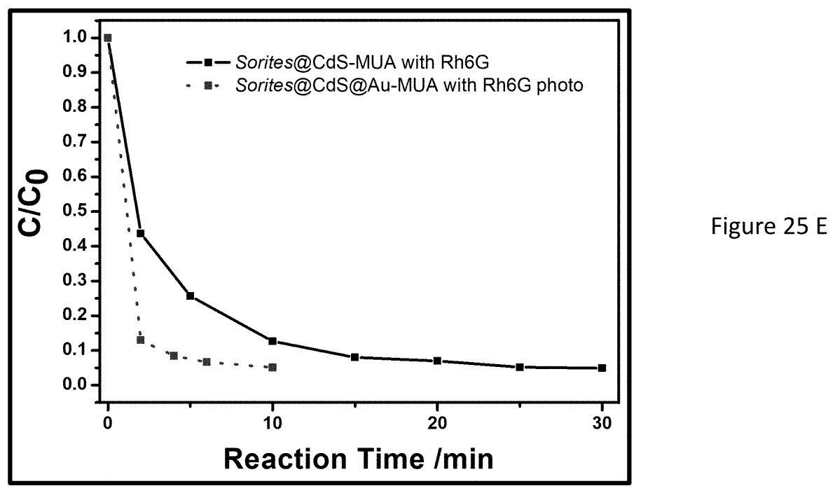

To examine the electrocatalytic properties of the HSIN, Sorites@Co and Sorites@NiO were used as electrocatalysts. FIG. 25A presents the electrochemical performance of the hierarchal structure coated with Co or NiO materials. Electrode with silver paint as a control experiment was tested and the measured current of the silver paint electrode shows a maximum of ˜2 mA/cm² at 1 V vs. Ag/AgCl (FIG. 25A respectively).

While the electrodes with Sorites@Co or Sorites@NiO show a maximum current of 154.6 mA/cm² and 73.5 mA/cm² at 1V vs. Ag/AgCl and an onset potential of about 0.55 V vs. Ag/AgCl (FIG. 25A), respectively. These currents are one of the highest reported electrocatlytic current using cobalt and nickel based material. This high performance may be attributed to the high surface area of the obtained structure, reaching easily to the interior surface of the 3D structures and may be due to confining the reactant in the 3D structures.

Water Purification.

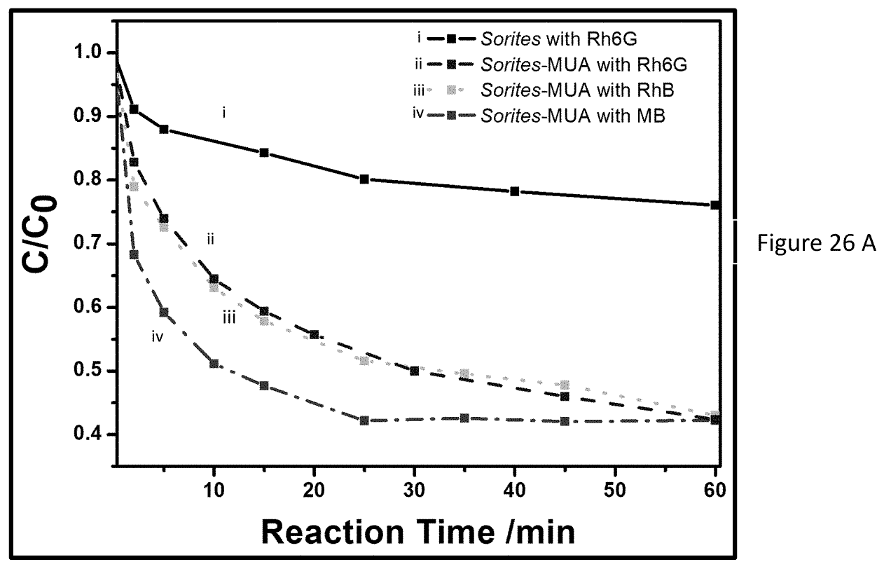

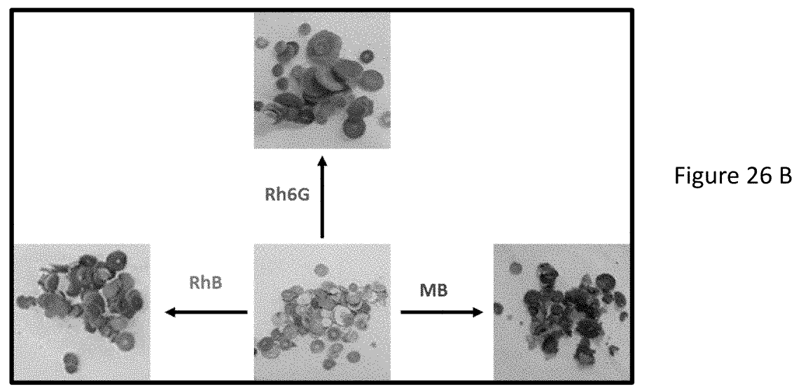

Next, the removal of two groups of materials, organic (dye molecules) and cation (heavy and non-heavy metal ions) was tested. The first examined group of materials in the water purification process is the organics dye molecules. The organic molecules were used as a case study due the simplicity to evaluate the purification process. Sorite treated with MUA and Sorites@CdS was used to study the ability of the prepared structure to adsorb Rh6G (as a case study) from solution (pH 10), and the adsorption of the dye molecules was monitored by UV-vis (FIG. 25B). A control experiment was carried out using 40 mg of pure Sorites to filter Rh6G molecule from the solution as shown in FIG. 25B. It can be seen in the control experiment that the ability of 40 mg of Sorites to adsorb Rh6G molecule is very low (less than 24% within 60 min, black trace). While after modification of the Sorites surface with MUA, the adsorption percentage of the dye molecule increases up to 57% within 60 min as shown in FIG. 25B and FIG. 25C. Furthermore, Sorites (after surface modification) shows a good adsorption ability for different dye molecules such as Rhodamine B (RhB) and Methylene blue (MB) as shown in FIGS. 26A-B.

Coating the Sorites (40 mg) with less than 1 mg of CdS followed with dyeMUA treatment, increases the adsorption percentage up to 86% within 60 min. Moreover, filtering the sample by cycles (replacing the used Sorites@CdS after 20 min with new Sorites@CdS) increased the percentage of the removed molecules up to 95% and decrease the reaction time to 30 min as shown in FIG. 25B. The initial concentration of the dye is 5.4 μM (2.7×10⁻⁸ mole) which decreased to 0.29 μM (1.5×10⁻⁹ mole). The optical images of Sorites@CdS before and after the adsorption experiment are shown in FIG. 25D, which provides another visual evidence for the success of the adsorption process. The color of Sorites@CdS changed from yellow (before-upper image) to red (after-lower image).

The prepared 3D structure was further examined as a photocatalyst for dye degradation process. FIG. 25E shows the photodegradation results, when Sorites@CdS and Sorites@CdS—Au (Au material was growth by sputtering approach using 100 mA current and exposure time of 3 sec on each side) were used. These results show that the Rh6G concentration decrease faster when the Au was coated the CdS (after 1 min, the concentration decrease by 87% compared to 56%). This enhancement is attributed to the formed heterojunction between the CdS and the Au, which facilitates the charge separation leading to improve in their photodegradation performance.

FIGS. 26A-B present adsorption of various dye molecules (Rh6G, RhB and MB) on Sorites surface (FIG. 26A), and optical images of Sorites before and after adsorption of the dye molecules (FIG. 26B).

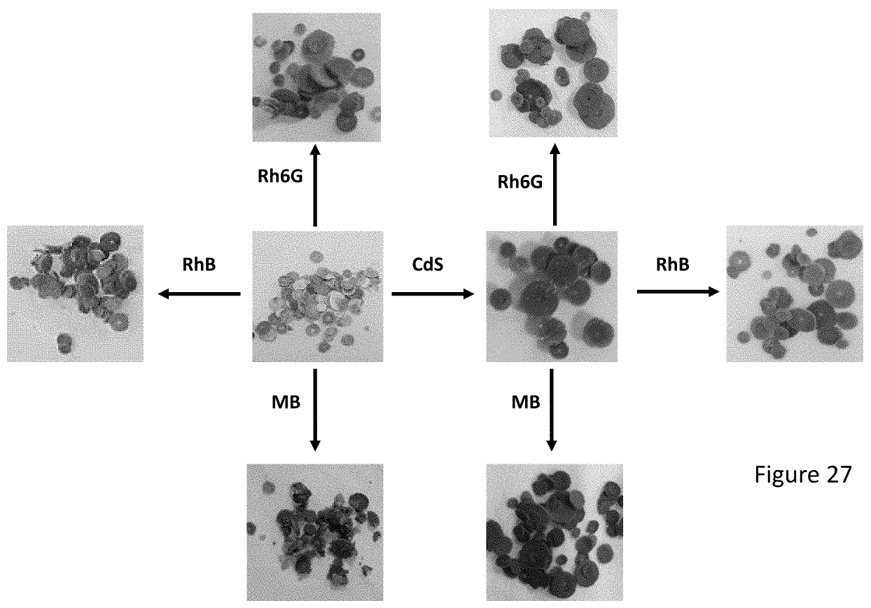

For the metal ions purifications, the Sorites were coated with Fe(OH)ₓ as shown in FIG. 27. Iron based oxides are promise candidate materials for extraction of metal ions from water/wastewater. Iron hydroxide are a particularly interesting phase in metal ions removal, due to their exposed hydroxide groups on its surface. (≡FeOH+M²⁺⇄≡FeOM⁺+H⁺).

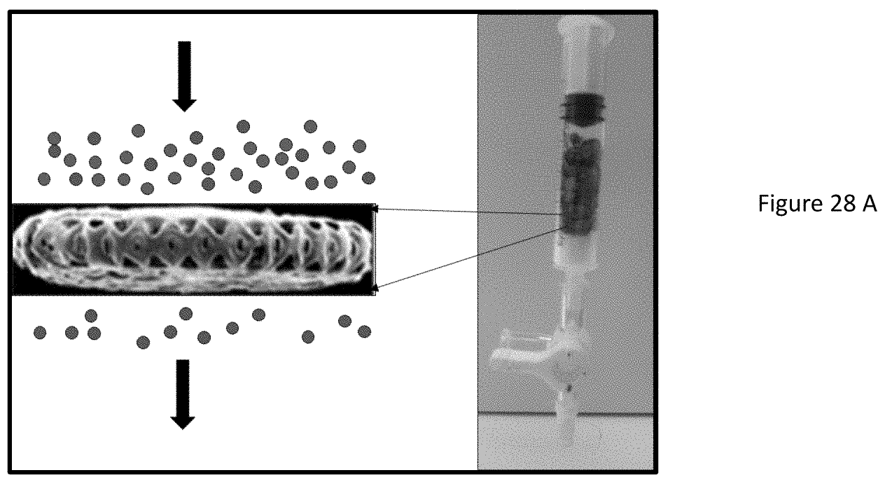

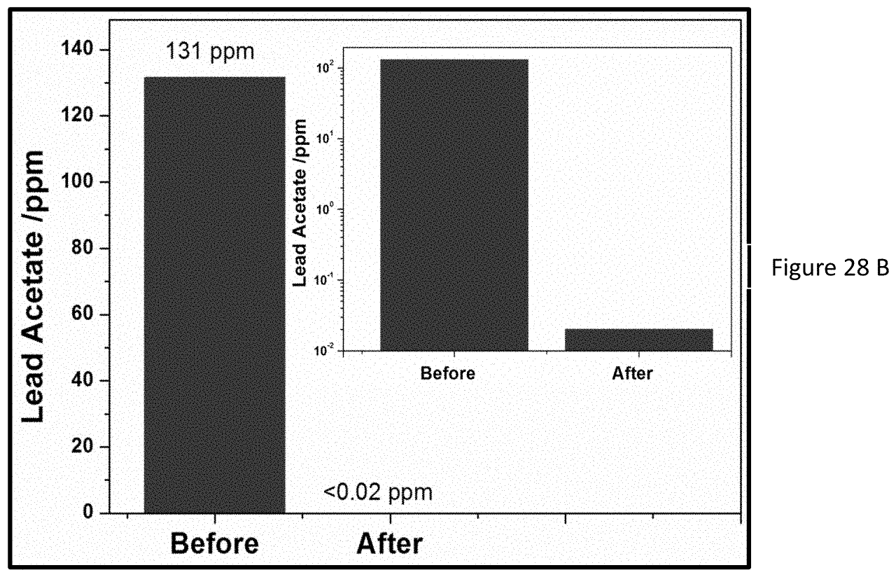

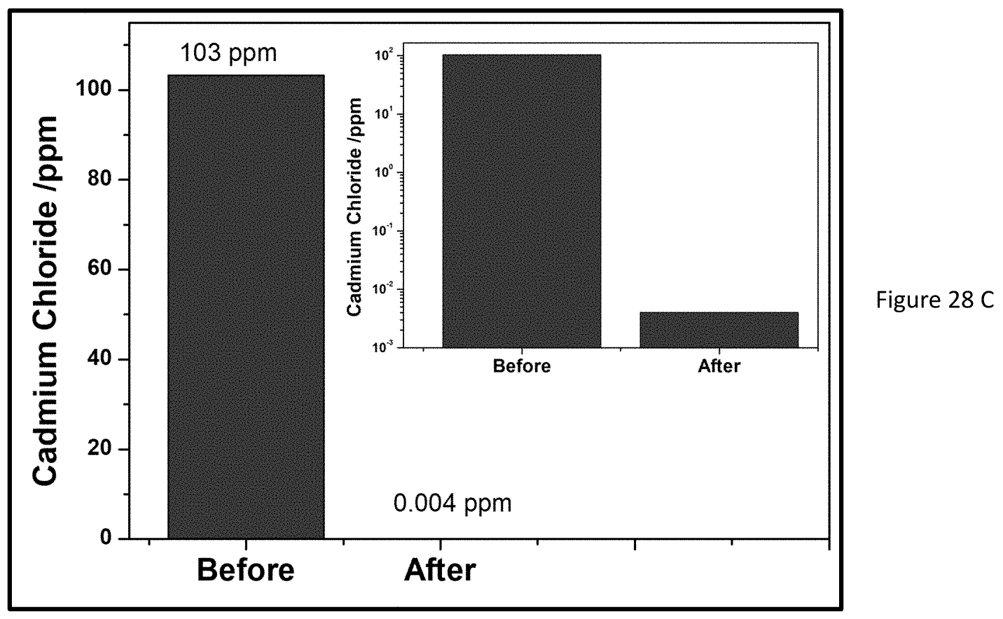

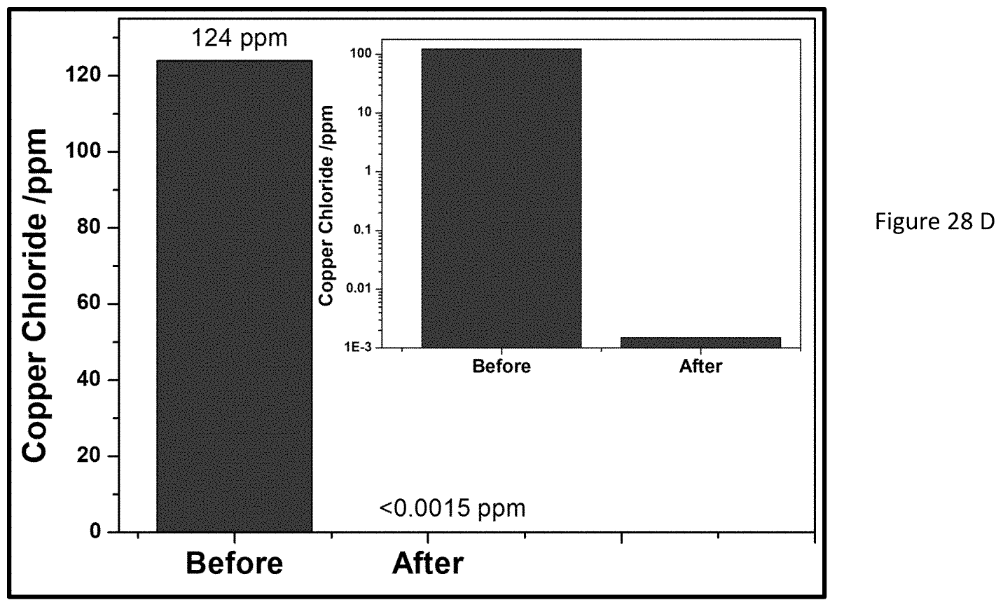

FIG. 28A shows the photographic image of the filter and a schematic description of the filtration process, in which the flow rate of the output was controlled by a valve. The performance of the filter was examined with three different solutions contaminated with specific cation such as Pb²⁺, Cd²⁺ or Cu²⁺. The solutions were prepared using Pb(ac)₂.3H₂O, CdCl₂ and CuCl₂, respectively. The concentrations of the cations were measured before and after the filtration using AAS. The measured amount of lead before and after the filtration were 131 ppm and <0.02 ppm, respectively, that is a 99.98% of the lead contamination was removed, as shown in FIG. 28B. The second contamination solution studied was the CdCl₂ solution. The AAS measurement showed a reduction of the cadmium content from 103 ppm to 0.004 ppm after filtration that is a reduction of 99.99%, as shown in FIG. 28C. The copper contamination was reduced by 99.99% from 124 ppm to 0.0015 ppm, as shown in FIG. 28D. The adsorption of the metal ions was further verified with EDS elemental atomic analysis measurements. The presence of the metal ions on the Sorites@Fe(OH)ₓ surface was examined. A homogenous adsorption was demonstrated, with the metal presence on all the structure. The performance of the filter consider as one of the best filters performance compared with filters those do not mixing activated carbon with the active material.

Taken together, the use of calcareous foraminiferal shells as scaffolds and subsequently removing it under mild conditions following coating with the inorganic or the organic materials presents a clear advantage compared to other biological scaffolds.

Furthermore, the size of the CFS is significantly larger than the size of other scaffold such as diatoms which facilitates their use in various applications. The thermal decomposition of single source precursors and photo-reduction of metal salt processes were utilized to grow a wide range of materials with different properties. Both methods provide simple and cheap procedures to achieve a large quantity of coated materials.

Three different potential applications for the 3D structures were demonstrated; water oxidation, photocatalytic and water purification. These unique 3D structures disclosed here have the potential to be used in wide range of other applications such as cell culturing, batteries, filters, photonic crystals, mask to grow different materials on substrates and other.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising porous mineral nucleus and a shell, wherein said porous mineral nucleus comprises a porous surface, said porous surface comprises at least 500 pores at a density of 500 to 5000 pores/cm², wherein each pore within said porous surface is 10 to 100 μm in diameter and 5 to 30 μm deep, wherein said pores are interconnected by a net of tunnels, wherein each tunnel of said tunnels is 1 to 40 μm in diameter, wherein said shell comprises a material selected from the group consisting of: a metal or an oxide thereof, a metal sulfide, an organic molecule, or a combination thereof.

2. The composition of claim 1, wherein said metal comprises a metal oxide, or a metal sulfide.

3. The composition of claim 1, wherein said metal oxide or said metal sulfide are selected from the group consisting of Fe₂O₃, MnO, NiO, CdS, Cu₂₋ₓS, PbS, or any combination thereof.

4. The composition of claim 1, wherein said metal is selected from the group consisting of: cobalt, zinc, potassium, tin, cadmium, lead, copper, gold, iron, or any combination thereof.

5. The composition of claim 4, wherein said metal is cobalt.

6. The composition of claim 1, being an electrocatalyst characterized by a current density of at least 250 mA/cm² in a water splitting process.

7. The composition of claim 1, wherein said organic molecule comprises a polymer, a dye molecule or both.

8. The composition of claim 7, wherein said dye molecule is Rhodamine.

9. The composition of claim 1, wherein said porous mineral nucleus is derived from calcareous foraminifera.

10. The composition of claim 1, comprising a plurality of shells.

11. The composition of claim 1, wherein said pores occupy 10 to 50% of said nucleus volume.

12. The composition of claim 1, wherein said pores occupy 10 to 50% of said nucleus surface area.

13. The composition of claim 1, wherein said porous surface comprises at least 1000 pores.

14. The composition of claim 1, wherein said density of 500 to 5000 pores/cm′ is density of 1500 to 4000 pores/cm².

15. The composition of claim 1, wherein said 1 to 40 μm in diameter is 5 to 20 μm in diameter.

16. An article comprising the composition of claim 1.

17.-28. (canceled)

29. The article of claim 16, being a filter for removing contaminants from water.

30. A process of fabricating the composition comprising porous calcareous nucleus and a shell, wherein said porous mineral nucleus is characterized by a pore density of 500 to 5000 pores/cm², and wherein said shell comprises a material selected from the group consisting of a metal, an organic molecule, or a combination thereof, the process comprising:
(a) immersing a calcareous foraminifera in a metal precursor, thereby producing a mixture thereof;
(b) heating said mixture,
thereby producing said composition.

31. (canceled)

32. A method for purification of contaminated water comprising the step of: contacting said contaminated water with the composition of claim 1.

33. The method of claim 32, wherein at least 95% of contaminants is absorbed onto said composition upon said contacting.
